(19) United States
(12) Patent Application Publication
(10) Pub. No.: US 2025/0030594 A1
(43) Pub. Date: Jan. 23, 2025

(54) CONTROL SYSTEM FOR CONFIGURING AND MONITORING A NETWORK SYSTEM

(71) Applicant: Oceus Networks, LLC, Herndon, VA (US)

(72) Inventors: Nusrat Atta, Flower Mound, TX (US); Faraz Haider Jafferi, The Colony, TX (US); Kevin Dean Stiles, Lantana, TX (US)

(21) Appl. No.: 18/776,827

(22) Filed: Jul. 18, 2024

Related U.S. Application Data
(60) Provisional application No. 63/514,531, filed on Jul. 19, 2023.

(51) Int. Cl. H04L 41/0803; H04L 41/00; H04L 41/085

(52) U.S. Cl. CPC H04L 41/0803; H04L 41/085; H04L 41/20

(57) ABSTRACT

A network control system is described and configured to monitor components of a cellular network system including routers, switches, radio units, network cores, etc., using one or more network configuration baselines. In some cases, the network control system can, based at least in part on the monitoring, modify one or more configurations of a component of the cellular network system.

### INCORPORATION BY REFERENCE TO ANY PRIORITY APPLICATIONS

Any and all applications for which a foreign or domestic priority claim is identified in the Application Data Sheet as filed with the present application are incorporated by reference under 37 CFR 1.57 and made a part of this specification. For example, the present application claims priority to U.S. Prov. App. No. 63/514,531, which is incorporated herein by reference for all purposes.

### BRIEF DESCRIPTION OF THE DRAWINGS

FIG. 1 is a block diagram illustrating an example of a communication network system.

FIG. 2 is a flow diagram illustrating an example of a routine for generating and using a preliminary network configuration baseline.

FIG. 3 flow diagram illustrating an example of a routine for monitoring a cellular network system using a network configuration baseline.

FIG. 4 is a flow diagram illustrating an example of a routine for merging network configuration baselines from different cellular network systems.

### DETAILED DESCRIPTION

Setting up a cellular network can be very complex and fraught with errors as cellular networks typically include many hardware components with particular configurations located in various geographical locations. Setting up a cellular network may also include the provisioning of many software components co-located with the hardware components and/or located in a cloud or shared computing resource environment. Similar to the hardware, the software components may have particular configurations for utilization of the cellular network. Moreover, the complexity of cellular networks and the number of various components located in various geographical locations can make it difficult to identify and address errors within the cellular network, should they arise.

Moreover, in some cases, multiple independent cellular networks may be associated together as part of a multinetwork cellular network. In some such cases, some or all of the independent cellular networks may be configured to include the relevant components to provide their own cellular network to user equipment independent of any or all components of another cellular network of the multinetwork cellular network. As such, the complexities of a cellular network system may be multiplied when multiple cellular networks are combined or associated as part of a multinetwork cellular network system. Accordingly, it will be understood that the components described herein to design, configure, deploy, and/or monitor a (single) cellular network and may also be configured to design, configure, deploy, and/or monitor a multinetwork cellular network.

To address the aforementioned issues, a network control system (NCS) can be utilized to design, configure, deploy, and monitor a cellular network (or multinetwork cellular network as referenced above). A designer may initially use the network control system in a design stage of a network to select components for a particular network. Based on the design, a network operator may configure, deploy, monitor, and/or set up the hardware components for the network, using the network control system to verify that the assembly follows the design. The connection between the components may be wired or wireless. In addition, using the design, a network operator may configure the hardware and/or software components in accordance with the design specifications. Thus, the network control system may be utilized to configure the components for the determined network specifications. The components of the network (i.e., the hardware and/or software components that make the network available for use to user equipment, etc.), their interconnections, and their particular configurations may be stored within the network control system as a network configuration baseline. The network control system may use the network configuration baseline to monitor the network and network components during use. In some cases, a network control system may store multiple network configuration baselines. In some such cases, one of the network configuration baselines may be designated as an active network configuration baseline and used to monitor the components of the communication network system and/or subsystem.

The network control system may also indicate to a user if an issue has been detected within the network using the network configuration baseline (e.g., issue an alert if the setup or configurations of one or more network components do not conform with the network configuration baseline). As described herein, alerts may be displayed on a graphical user interface (e.g., as part of a dashboard or other user interface), send to a user, etc.

The network configuration baseline may also be utilized to reconfigure components on the network, combine multiple networks into one network, split a network into multiple networks, etc. Furthermore, the network control system may be configured to retrieve information associated with the network (e.g., machine data from network components, usage, use cases, etc.) and analyze the data retrieved (e.g., using a machine learning model) to identify errors, security risks, data breaches, etc.

In some cases, the network control system may track the individual state of one or more components of a subsystem of the network as part of a system configuration baseline (or subsystem configuration baseline). The system configuration baseline may identify a subset of the components of the network and one or more baseline configurations for the subset of components. In some cases, the subsystem baseline may correspond to the network components of a particular system, at a particular geographic location, and/or that provide a particular feature or function.

The network control system may also analyze key performance indicators from the data collected from the components within the network and apply a machine learning model to detect possible errors within the network, as well as optimize the network, profile network behaviors, and perform automation.

In some cases, there may be a primary network control system that corresponds to the (entire) cellular network (or multinetwork cellular network) and one or more secondary network control systems for subsystems of the cellular network (or to an individual cellular network of a multinetwork cellular network). In scenarios where a secondary network control system corresponds to an independent cellular network of a multinetwork cellular network, secondary network control system may include additional secondary (or tertiary/quaternary network control systems for subsystems of the cellular network). In some cases, the secondary network control systems may perform the same or similar functions as the primary network control system but for a subset of the components of the cellular network and/or for a subsystem (or a particular cellular network of the multinetwork cellular network system). Furthermore, it will be understood that there may be multiple layers of multinetwork cellular networks where the top level multinetwork cellular network system includes a primary network control system, and sub-multinetwork cellular network systems include secondary network control systems.

In certain cases, a secondary network control system may correspond to or be used in conjunction with a system configuration baseline (or the components included in the system configuration baseline). In some cases, the secondary network control may be used or configured to: design a cellular network, configure a cellular network, deploy a cellular network, monitor a cellular network, verify assemblies to a design, store network configuration baselines, alert issues detected to a user, determine network information, track individual states of one or more components of the network, and analyze key performance indicators from data collected from components.

The systems and methods described herein provide a technical solution to a technical problem arising in cellular networks and multinetwork cellular networks that cannot be performed by a human. For example, the system described herein can provide continuous and concurrent real-time monitoring of tens, hundreds, or more distinct hardware and software cellular network components, each with its own set of parameters and configurations. As part of the monitoring, the system can in real-time continuously and concurrently collect disparate types of parameters (including machine generated data) in disparate formats using disparate collection techniques from different cellular network hardware and software components of the system. In many cases, the data retrieved may be streaming data that might otherwise be lost if not collected by the control system. Moreover, the system can provide a real-time status of any of the components of the cellular communication system at any time. The amount, type, and transitory nature of the (streaming) data makes it impossible for a human to collect, monitor, evaluate, and assess alone, let alone in real-time (e.g., in less than one or a few seconds).

In addition, in some cases, the control system can automatically, without human intervention, adaptively modify or configure one or more components of the communication system. For example, the control system may, based on the collected, real-time data, modify or reconfigure, in real-time, a hardware and/or software component of the communication system. As such, the control system may improve the functioning of the communication system by decreasing downtime, and increasing network reliability, resiliency and/or throughput in a cellular network or multiple cellular networks.

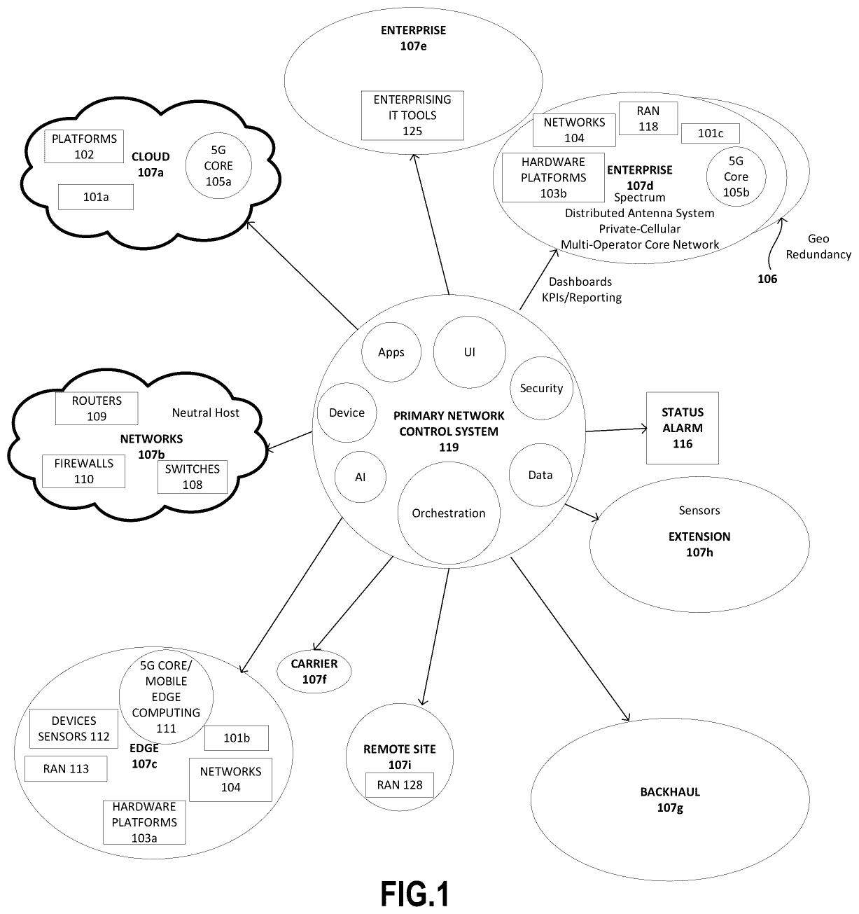

FIG. 1 is a block diagram illustrating an example of a multinetwork communication network system 100 (also referred to herein as a communication network system 100) configured to provide a multinetwork communication network (also referred to herein as a communication network). The communication network system 100 includes a primary network control system 119, secondary network control systems 101a, 101b, 101c (individually or collectively referred to as secondary control system(s) 101, and various hardware and/or software components (individually or collectively referred to as network components), such as, but not limited to, routers 109, switches 108, firewall 110, cellular network cores (e.g., 5G Core) 105a, 105b (individually or collectively referred to as network core(s) 105), such as but not limited to a 4G core or 5G core, etc., radio access network (RAN) devices 113, 118, 128, multi-access edge computing (MEC) devices 111, Multi-Operator Core Networks (MOCN), etc. Fewer, more, or different components may be included in the communication network system 100.

### Network Components

The components of the communication network system 100 may further include components that help form the communication network (e.g., create the communication links that enable user equipment to communicate via the communication network), such as network cores, RANs, routers, switches, firewalls, etc., components that monitor the communication network or other components (e.g., sensors and/or devices that monitor the communication network and/or other network components to identify errors, malfunctions, etc.), and/or components that provide services to user equipment that attach to the communication network (e.g., servers that provide certain services or functionality to the UE that attach to the network). It will be understood that some components of the communication network system 100 may be configured to self-monitor and/or provide monitoring data (e.g., metrics, log data, metadata, etc.) to a network control system 101 or 119. It will be understood that other user equipment may connect and/or use the communication network that is formed by the communication network system 100.

The network components may be located in various locations and communicate with each other and/or the primary network control system 119 and/or a respective secondary network control system 101 via one or more communication links (e.g., Wi-Fi, fiber, satellite, microwave, or other backhaul technology, etc.) or other links, such as but not limited to a LAN, WAN, the Internet, a network of mobile devices, multiple cellular networks, a combination of the same, or the like.

Each component of the communication network system 100 may be connected to other components of the network and/or may have unique and/or particular configurations. For example, switches 108 may have 10 ethernet cables plugged into the switches 108. Similarly, a RAN device 113 may be configured to operate within a particular frequency band. Similarly, a network core 105 may be configured to enable communications between a particular number or a specific group of user equipment. The network further may include a firewall 110 for increased security utilized for monitoring network traffic.

The network core 105 may include, but is not limited to, a user plane function (UPF) component, session management function (SMF) component, access and mobility management function (AMF) component, policy control function (PCF) component, etc. The UPF may serve as a communication component with a RAN device 113 and a communication link. The UPF may further conduct packet inspection, traffic routing, and packet processing before providing data packets to the communication link. The SMF may be utilized for establishing, maintaining, and terminating network sessions for the various network components. The AMF receives policy control information, session-related information, and authentication information from the network components and provides component details to network functions. The PCF provides policies for the network components to prescribe to.

Additionally, the primary network control system 119 may retrieve data collected from the network core 105. For example, the data collected from the routers 109 may include, but is not limited to, session established success rates, user data throughput, control plane latency, control processing unit (CPU) usage, memory usage, session management logs, mobility management logs, authentication logs, security logs, system performance logs, subscriber data flows, control plane signaling flows, interconnect traffic, Quality of Service (QOS) policy enforcement, etc.

The data retrieved by the primary network control system 119 are non-limiting examples of the types of data that may be collected from the network core 105. Additional types of data not disclosed may also be collected by the primary network control system 119.

The RAN device 113 may include, but is not limited to, a base station, various types of antennas for different frequency bands, radio frequency (RF) transceivers, base band unit (BBU), etc. A base station may be utilized for transmitting and receiving radio signals to the network components and/or to user equipment. The RF transceivers coupled with the various types of antennas, utilized for transmitting and receiving wireless network transmission. Furthermore, the BBU is configured to interpret baseband frequencies via a set of signal processing functions.

As described herein, the RAN device 113 may include a variety of configurations or settings including, but are not limited to, transmission settings, frequency settings, power settings, beamforming settings, etc. The transmission settings may include configured power levels and antenna configurations of the RAN device 113. The frequency settings may include a list of frequency bands, and configurations of the frequency bands and carrier aggregation settings. The power settings may include configuration regarding power consumption during a specific transmission setting of the RAN device 113. The beamforming settings may include configuration information of establishing beamforming processing for signal transmission, including antenna array setting, and configuration information for smart antennas.

As described herein, the BBU may include a variety of configurations or settings including, but limited to, public land mobile network (PLMN) configurations, access and mobility management function (AMF) endpoints, timing source settings, global positioning system (GPS) configurations, performance settings, etc. The BBU configurations may also include a list of PLMNs supported by the BBU. The AMF endpoints may form part of a 5G core 105a and corresponding configurations may include a list of AMFs that the baseband is pointed to. The timing source settings may include configuration information for timing synchronization across network components. The GPS configurations may include initialization of a GPS device that may be configured to operate on or with the BBU. The performance settings of the BBU may include parameters for improved throughput, latency, reliability, etc.

Additionally, the primary network control system 119 may retrieve data collected from the RAN device 113. For example, the data collected from RAN device 113 may include, but is not limited to, signal quality indicators (signal-to-interference-plus-noise-ratio (SINR), received signal strength indicator (RSSI)), bandwidth usage, CPU usage, memory usage, latency, jitter, radio resource management logs, system performance logs, error logs, security logs, user data traffic, control signaling traffic, handover statistics, traffic per frequency band, etc.

The data retrieved by the primary network control system 119 are non-limiting examples of the types of data that may be collected from the RAN device 113. Additional types of data not disclosed may also be collected by the primary network control system 119.

The network switches 108 may include various physical ports, network interface cards (NICs), one or more processors, and volatile and non-volatile memory. The various physical ports provide additional connectivity to the network via a hardwire connection. The NICs facilitate data transmission and receiving from the various physical ports. The processor is configured to process data received or data transmitted regarding routing protocols and management tasks. The memory is configured to store firmware for the switches 108, also included in the memory may be data stored by the processor after data processing is completed.

The components of the communication network system 100 may additionally include various types of antennas and power amplifiers. The various types of antennas may include multiple-input multiple-output (MIMO) antenna and beamforming antenna. The MIMO antenna is comprised of multiple antennas and transceivers where data is to be transmitted by dividing the data into multiple data streams. The data streams are transmitted by the MIMO antenna utilizing the same bandwidth. A beamforming antenna may be used to transmit a very narrow beam rotatable to a desired direction. The power amplifier may be used for signal amplification to increase the power of the output signal of the various antennas.

Additionally, the primary network control system 119 may retrieve data collected from the various types of antennas. For example, the data collected from various types of antennas may be, but is not limited to, transmission power levels, signal quality indicators, uplink/downlink throughput, interference levels, transmission logs, system performance logs, error logs, security logs, user data traffic, control signaling traffic, traffic per cell, handover statistics etc.

As described herein, the switches 108 may include a variety of configurations or settings including, but limited to, protocol configuration, security settings, interface configurations, virtual local area network (VLAN) configurations, etc. The protocol configuration information may include open shortest path first (OSPF) configuration information, border gateway protocol (BGP) configuration information, static routes, etc. The security setting configuration may include firewall 110 rules, virtual private network initialization information, etc. The interface configurations may include IP address, subnet masks, interface type, etc. Additionally, the VLAN configurations may include VLAN identification, VLAN membership of an interface, trunk port assignment, etc.

The data retrieved by the primary network control system 119 are non-limiting examples of the types of data that may be collected from the various types of antennas. Additional types of data not disclosed may also be collected by the primary network control system 119.

The network may include network components that are software components (e.g., firewalls 110, operating systems, applications, etc.) The firewalls 110 operate as the network security measure, monitoring incoming and outgoing data traffic of the network. The firewalls 110 may include features such as access control, which moderates a network component access to the network. Additionally, firewalls 110 may include features of logging details regarding the network traffic and identified threats, stored in a log for a user review. The network components may include operating systems as part of the network components. The operating systems may include various types of operating systems and various versions of the operating system for each network component on the network. The routers 109 may include a specific operating system for routing data traffic and may further include various versions of the operating system. The various network components include various operating systems each that may be independent from one another, and the various operating systems each may include various versions of the operating system.

As described herein, the software components may include a variety of configurations or settings including, but limited to, software versions, security settings, Application Programming Interface (API's), logging data, etc. The configuration for the various software versions may include current software versions, update history, patches, and updates, etc. The security settings may include configuration information such as role-based access control (RBAC), data encryption configuration, and data protection policies. The API configurations may include information related to API services, port exposing, API utilization, API authentication. The logging data configurations may include log location files, retention policies, and the like.

The network configuration baselines may be dependent on the type of network component that are configured to be part of the network including the respective software associated with the network components. The network configuration baseline may include hardware components in the network such as platforms 102 (e.g., servers), a 5G core 105a, and a secondary network control system 101. Additionally, the network configuration baseline may include additional hardware components such as routers 109, firewalls 110, and switches 108. The network configuration baseline may include any variation of the hardware components and may include multiple hardware components that may be operating using different operating systems. For example, there may be a network configuration baseline that includes multiple routers 109 where one of the routers 109 is operating on an earlier version of an operating system than the other routers 109. The example of the router 109 is a non-limiting example, used only as an explanation that other network components may also follow the same example.

As described herein, the routers 109 may include a variety of configurations or settings including, but limited to, protocol configuration, security settings, interface configuration, virtual local area network (VLAN) configuration, etc. The protocol configuration may include a variety of settings, such as but not limited to, open shortest path first (OSPF) configuration information, border gateway protocol (BGP) configuration information, static routes, etc. The security setting configurations may include specified firewall 110 rules, virtual private network initialization information, etc. The interface configuration information may include IP address, subnet masks, interface type, etc. Additionally, the VLAN configuration information may include VLAN identification, VLAN membership of an interface, trunk port assignment, etc.

Additionally, the primary network control system 119 may retrieve data collected from the routers 109. For example, the data collected from routers 109 may include, but is not limited to, packet forwarding rates, interface statistics, routing table information, latency, jitter, routing updates, interface status logs, security logs, event logs, traffic volume per interface, source/destination internet protocol (IP) statistics, protocol distribution QoS enforcement statistics, etc.

The data retrieved by the primary network control system 119 are non-limiting examples of the types of data that may be collected from the routers 109. Additional types of data not disclosed may also be collected by the primary network control system 119.

### Subnetworks or Subsystems

In some cases, various network components may be organized into one or more subnetworks or subsystems 107a, 107b, 107c, 107d, 107e, 107f, 107g, 107h (individually or collectively referred to as subsystem(s) 107). The different subnetworks or subsystems 107 may be located in the same or different geographical locations. In the illustrated examples, the subsystems 107 are shown with particular components. It will be understood that the subsystems 107 may include fewer or more components with different configurations as desired. Accordingly, the illustrated examples of subsystems 107 should not be construed as limiting.

In certain cases, the subsystems 107 may operate independent of the other subsystems 107 and/or the primary network control system 119. For example, the subsystem 107d may be configured to provide an independent private cellular network to user equipment within the coverage areas of the subsystem 107d. In some such cases, the communication network system 100 may form a multinetwork cellular network that includes multiple independent cellular networks. In creating the private cellular network independently, the subsystem 107d may provide communication links between user equipment without communication to another subsystems 107 and/or the primary network control system 119. The subsystems 107 may be configured independently of the communication network system 100. The subsystems 107 may further be configured to operate using different communication standards than other subsystems 107 (e.g., LTE vs. 5G vs. 3G, etc.). Additionally, the subsystems 107 include different configuration parameters regarding the different communication standards. In certain cases, the different subsystems 107 may operate in different frequency bands and/or use incompatible configurations or components.

Moreover, in some cases, the subsystems 107 may be movable or mobile (e.g., the subsystems may be able to function and/or generate communication networks while moving). For example, the subsystem 107c may move closer to or farther away from the subsystem 107d, while both subsystems 107c and 107d are providing communication links to user equipment within their respective coverage areas.

In the illustrated example, the subsystem 107a is implemented as a cloud-based subsystem that includes a 5G core 105a, various platforms 102 (e.g., servers), and a secondary network control system 101a. Such a system may be used as a remote storage system that may be accessed by a user remotely. The platforms 102 or servers may be implemented using one or more processors and memory and store system logs, application logs, security logs, performance logs, etc. and can be accessed by the primary network control system 119 and the secondary network control system 101a. Primary network control system 119 and secondary network control system 101a may retrieve from the platforms 102, data related to processor utilization, memory usage, hard disk input/output rates, network bandwidth usage, latency, response time, inbound/outbound traffic volumes, connection counts, connection duration, packet loss, application specific traffic patterns, login attempts, etc. The data retrieved by the primary network control system 119 and secondary network control system 101a are non-limiting examples of the types of data that may be collected from the platforms 102. Additional types of data not disclosed may also be collected by the primary network control system 119 and secondary network control system 101a.

The 5G core 105a may be communicatively coupled to a RAN 128 of a remote site (subsystem 107i) and provide network access to user equipment (not shown in the figure) that is within the coverage area of the remote site.

As described herein, the 5G core 105a (or other type of cellular network core) may include a variety of configurations or settings including, but limited to, network function configurations (e.g., access and mobility management functions (AMF), session management function (SMF), user plane function (UPF), public land mobile networks (PLMNs), security setting, etc. The network function configurations may include AMF, SMF, and UPF configuration. The AMF configurations may include an AMF identification, network slicing support choosing a specific slice, network-attached storage (NAS) configuration information, various timers, such as session timers, etc.

The SMF configuration may include configuration information such as, distributed network name (DNN), quality-of-service (QOS) profiles, power distribution unit (PDU) sessions configuration. The UPF configuration may include configuration information such as N3/N9 interfaces configuration, QoS profiles, packet processing rules, resource allocation, etc. Furthermore, the configuration information of the PLMN may include a list of PLMNs that may be supported by the 5G core 105a. The configuration information of the security settings may include authentication method configuration data, encryption setting configuration data, and access control configuration data.

The RAN 128 may be configured to facilitate wireless communication between the network components and/or UE and the 5G core 105a. The RAN 128 is managed and/or monitored by the primary network control system 119 and/or the secondary network control system 101a.

The platforms 102 may be configured to operate as a remote storage center (e.g., a server) for the primary network control system 119. Furthermore, the secondary network control system 101a may further utilize the platforms 102 for storage. The primary network control system 119 and secondary network control system 101a may store network configuration baselines in the platforms 102 for future network configurations.

As described herein, the platforms 102 (or servers) may include a variety of configurations or settings including, but limited to, CPU allocation, memory allocation, disk allocation, etc. The CPU allocation may include assignment of CPU resources for predefined tasks executed by the CPU, distributing processing power, etc. The memory allocation may include assignments of portions of the memory to various programs and processes within platform 102 and may operate dynamically. The disk allocation may include allocated disk space on a non-transitory storage medium for specific tasks and/or applications. Furthermore, the disk allocation may include disk partitions configuration and file allocation configuration information.

As described herein, the secondary network control system 101a may collect data from the network components, such as the servers or platforms 102 and the 5G core 105a, analyze the data, and generate alerts. The secondary network control system 101a may determine, based on the retrieved data, that the network components may route the data to the primary network control system 119. The primary network control system 119 may determine the network components configuration do not match the network configuration baseline. Similarly, the secondary network control system 101a may determine the network configuration of the network components do not match the network configuration baseline. Based on the determination, the secondary network control system 101a may determine to modify the configurations of the affected network component to revert their configurations to the network configuration baseline. In some cases, the secondary network control system 101a may generate an alert to a user and indicate that the network components configuration does not match the network configuration baseline.

In certain cases, the secondary network control system 101a may determine to generate a second network configuration baseline based on the changed (or unmatching) configuration. The secondary network control system 101a may determine to utilize the second network configuration baseline for monitoring the network components.

In the illustrated example, the subnetwork or subsystem 107b includes routers 109, firewall 110, and switches 108. As described herein, the routers 109 may be used to route data to various users of the network. In some cases, the subsystem 107b may include various types of routers 109 operating on various versions of an operating system. The network configuration baseline of the primary network control system 119 may identify the type of routers 109 as part of the subsystem 107b and further identify the version of an operating system the routers 109 is required to operate on.

The firewall 110 operates as a network security measure, monitoring incoming and outgoing data traffic of the network. The firewalls 110 may include features such as access control which moderates a network component access to the network. Additionally, firewalls 110 may include features of logging details regarding the network traffic and identified threats, stored in a log for a user review. The network components may include operating systems as part of the network components. The operating systems may include various types of operating systems and various versions of the operating system for each network component on the network.

The switches 108 include various physical ports to provide additional connectivity to the network via a hardwire connection. The switches 108 facilitate data packet exchange between network components and the primary network control system 119. Additionally, the switches 108. The subsystem 107b as illustrated does not include a secondary network control system, as such the primary network control system 119 is configured to retrieve data, analyze data, generate alerts, and provide configuration of the network components if determine it is required.

Additionally, the primary network control system 119 may retrieve data from the switches 108. For example, the data collected from switches 108 may include, but it not limited to, port utilization rates, error rates, media access control (MAC) address table changes, latency, jitter, port status logs, virtual local area network (VLAN) configuration changes, security logs, event logs, traffic volumes per port, VLAN traffic statistics, packet forwarding rates, and spanning tree protocol (STP) events.

The data retrieved by the primary network control system 119 are non-limiting examples of the types of data that may be collected from the switches 108. Additional types of data not disclosed may also be collected by the primary network control system 119.

The subnetwork or subsystem 107c includes a RAN device 113, multi-access edge computing (MEC) device 111, various sensors 112, a secondary network control system 101b, and various hardware platforms 103a (e.g., servers, etc.). As described herein, the RAN 113 device may be configured to facility wireless communication between components. In some cases, communications from the RAN device 113 may go to the 5G core MEC 111 and then to a network core 105. The RAN device 113 is managed and/or monitored by the primary network control system 119 and/or the secondary network control system 101b.

The MEC device 111 may enable cloud computing capabilities at the edge of the network closer to a UE. The MEC device 111 may include a custom application designed to run cloud computing capabilities closer to the network components as illustrated with subsystem 107c.

The sensors 112 may include various types of sensors (e.g., Internet-of-Things (IoT) devices, traffic sensors, performance sensors, environment sensors, etc.) that may be further used in series with the secondary network control system 101b and the primary network control system 119 to collect data. The secondary network control system 101b and the primary network control system 119 may utilize sensor data received by the sensors 112 to further determine the network components are configured to the primary network baseline configuration or a secondary network baseline configuration. Furthermore, the secondary network control system 101b and primary network control system 119 may further use the sensor data obtained by the sensors 112 to generate an alert based on a network component configuration discrepancy. It will be understood, however, that the primary network control system 119 and/or secondary network control system 101 may identify network errors or discrepancies based on data collected from any one or any combination of components of the network communication system 100 (e.g., with or without sensor data).

Hardware platforms 103a may further include various types of components utilized in a network. For example, various hardware platforms 103a may include components such as antennas, integrated radios, user equipment (UE), etc. The network slicing software includes features that enable the division of the network into multiple virtual networks and virtual private networks (VPNs). The primary network control system 119 and the secondary network control system 101b may further configure and reconfigure components and features of the VPNs based on a network configuration baseline. The UE, as connected to the network, may further include configuration data. The primary network control system 119 and secondary network control system 101b additionally may monitor, generate an alert, and reconfigure the UE.

The secondary network control system 101b may actively monitor the network components in real-time. Additionally, the secondary network control system 101b may actively generate a second network configuration baseline based on the determination the network components configuration has been altered. The secondary network control system 101b may generate an alert indicating that the network component configuration has been altered. The secondary network control system 101b may further determine to transmit data to the primary network control system 119 for the primary network control system 119 to process the data collected from the network component devices. The primary network control system 119 may generate an alert based on a determination that the network component configuration has been altered. The primary network control system 119 may determine to generate a second network configuration baseline or revert back to the network configuration baseline.

The subnetwork or subsystem 107d may be implemented to support a group of computer devices that may be configured to serve the need of a large business known as an enterprise network. An enterprise network may contain a distributed antenna system (DAS), private-cellular network, multi-operator core network (MOCN) standard implemented with RAN device 118, a 5G core 105b, hardware platforms 103b (e.g., servers, etc.), network devices (e.g., routers, switches, firewalls, etc.) 104, and a secondary network control system 101c. The subsystem 107d may also include backup components for some or all of its components as part of a geographic redundancy 106.

The primary network control system 119 is also communicatively coupled with the subnetwork or subsystem 107e, which includes an enterprise network with pre-existing IT tools 125; the subsystem 107f, which corresponds to a cellular network carrier (e.g., T-Mobile, Verizon, etc.); the subsystem 107g, which corresponds to one or more backhauls, such as but not limited to, radio backhaul, fiber backhaul, microwave backhaul, satellite communication backhaul, mobile ad hoc network etc.; and the subsystem 107h, which includes one or more sensors, IOT devices, and/or gateways, etc.

Given the large number of components, subnetworks, and/or subsystems 107 of the communication network system 100 and the many possible configurations for each component, it may be difficult to ensure the communication network system 100 (including the components thereof) is setup and continues to be configured properly and/or to monitor the communication network system 100 to identify errors or malfunctions in the components.

As described herein, the configurations for the different components of the communication network system 100 may be based on the type of components. The various network components of the communication network system 100 include individual software components that corresponds to the network components (i.e., operating systems). Additionally, the network components may further include different versions of the software components that may independently be used for an individual network component of the same type of network components.

For example, the configuration of some components (e.g., switch or router) can be dependent on a correct port assignment of the routers 109 and/or switches 108. If the component is not connected to the correct port as per the assignment an error is indicated. The primary network control system generates and alert and may revert the component configuration settings to the network configuration baseline.

Additionally, other examples of different configuration types of the communication network system 100 are access point name (APN) configuration of the network components. The APN may be different based on the individual network component. The primary network control system 119 may determine if the correct APN is configured with the corresponding network component.

Additionally, network slicing software may include features to enable the division of the network into multiple virtual networks with configuration to define network slices. The primary network control system 119 can configure the network slicing software to create partitions of the network to be allocated based on a configured requirement.

In some cases, the primary network control system 119 can configure the utilization of Synchronous Connection-Oriented (SCO) or Asynchronous Connection-Less (ACL) Baseband link about the network components. For example, the SCO may enable a point-to-point link established between a network component and a UE utilizing a Bluetooth connection. Additionally, the ACL may enable a point-to-multipoint link between a network component and a UE utilizing a Bluetooth connection.

In certain cases, the primary network control system 119 can configure communication channels for routers 109 and switches 108. The primary network control system 119 may have an optimized configuration for device connection with routers 109 or switches 108 that establishes connection with device using a low occupancy channel of a network frequency.

Additionally, configuration examples include, but are not limited to, the RAN device 113 configuration based on a distribution of the RAN device 113 in a geographical location. Furthermore, the RAN device 113 configured to transmit via a baseband unit, baseband signals. The RAN device 113 may comprise different baseband units that require alternative configurations. The primary network control system 119 may determine the RAN device 113 with the corresponding baseband unit and configure the RAN device 113 alternatively to other RAN device 113. The configuration of communication network system 100 is not limited to the examples described in the application, rather an example of types of configurations possible.

### Primary Network Control Systems

The primary network control system 119 can be configured to aid in the design, assembly, setup, configuration, and monitoring of the components of the communication network system 100 (throughout the descriptions, although reference is made to the primary network control system 119 and communication network system 100, it will be understood that a secondary network control system 101 may perform the same or similar functions for a subsystem 107). For example, a user may use the primary network control system 119 to identify the components, assembly, and configurations of the communication network system 100, as well as to monitor the network components while the corresponding network is active. In addition, the primary network control system 119 may be used to consolidate multiple communication network systems 100 or networks into fewer communication network systems 100 or networks or split a communication network system 100 or network into multiple communication network systems 100 or networks.

Moreover, the primary network control system 119 may monitor and/or manage the various network components, subnetworks, and/or subsystems 107 of the communication network system 100. For example, the primary network control system 119 may be configured to retrieve data (machine-generated data or other) from the network components as well as key performance indicators and use a machine learning model to identify anomalies, aberrations, network threats, malfunctions, behavior profiling, automation, etc. Furthermore, the primary network control system 119 may use supervised learning or unsupervised learning algorithms to identify errors within the communication network system 100. Additionally, machine learning models may be used to optimize network component configuration during an initial network component configuration.

An example of supervised machine learning models used by the primary network control system 119 may be Random Forest, Support Vector Machines (SVM), and Neural Network Algorithm. An example of the unsupervised machine learning models used by primary network control system 119 may be K-Means clustering algorithm and principal component analysis (PCA). The example machine learning algorithms as described above are merely example of algorithms the primary network control system 119 may utilize and are not considered to be limiting examples. Other machine learning algorithms not described may be implemented with the machine learning models of the primary network control system 119 for error detection, optimization, and profiling network behaviors.

The primary network control system 119 may utilize machine learning models to optimize network component configurations. For example, the machine learning model may determine to adjust a CPU and memory resources for network configuration baseline, establishing network slices for different services (e.g., video streaming, IoT device, etc.), adjusting antenna angles and power to improve signal strength, adjusting parameters for smooth handover between network components, configuring parameters for best routing protocols, and balancing power across nodes by distributing workload.

Machine learning models utilizing supervised learning may be trained from historical data collected from the primary network control system 119 and from synthetic data generated from simulation devices. The training data may include configuration parameters for network components for optimized performance of a specific network component, log data that may identify ordinary operation and operation while including an error, and error indicators. The machine learning model may learn to identify errors within the network and network components based on the training data during operations. Additionally, the primary network control system 119 may utilize the machine learning model to optimize initial configuration of the network configuration baseline.

Furthermore, the machine learning models utilizing unsupervised learning may be trained using network component configuration data, key performance indicators (KPIs), event data from generated alerts, and log data from network components that can identify ordinary operation and operations while including an error. The machine learning model may be trained utilizing threshold values based on historical data and/or industry standards for error detection. The primary network control system 119 may collect the training data from network nodes and the network components.

The primary network control system 119 may be implemented using one or more physical computing devices, such as microprocessor, microcontroller, etc. These computing devices can be physically co-located or can be geographically separate from each other. For example, the primary network control system 119 may be implemented using different computing devices located in different data centers. In certain cases, the primary network control system 119 may be implemented using one or more isolated execution environments, such as one or more software containers or virtual machines, executing in a shared computing resource environment. In the shared computing resource environment, multiple isolated execution environments may share hardware resources (e.g., volatile or non-volatile memory, non-transitory data storage devices, microprocessors, etc.) but operate independently of each other and not be aware that they are sharing computing resources. In some such cases, one or more isolated execution environment managers may manage the physical computing resources shared between the isolated execution environments.

### Design/Setup of a Communication Network System

A user may use the primary network control system 119 to design a communication network system 100 and/or network, such as a cellular network. This may include selecting components of the communication network system 100 that will be utilized to create the network. For example, the user may use the primary network control system 119 to determine whether the communication network system 100 will include one or more subnetworks or subsystems 107, the type of core(s) (e.g., 4G, 5G, etc.) or MEC included in the communication network system 100, the number of RANs, whether there will be routers and switches etc.

The user may also use the primary network control system 119 to assemble or set up the various components of the communication network system 100. (e.g., connect the various components). Furthermore, the user may use the primary network control system 119 to configure the assembled various components of the communication network system 100. In some cases, based on the preliminary design of the communication network system 100, the primary network control system 119 may generate a preliminary network configuration baseline (NCB), and use the preliminary NCB to assemble, set up, and/or configure the components of the communication network system 100. The primary network control system 119 retrieves data from nodes of the communication network system 100 that are configurable nodes based on the preliminary NCB and read only nodes that do not allow access to configure or modify configurations or settings. For example, the primary network control system 119 may retrieve data from components of the cellular network carriers (e.g., Verizon, T-Mobile, etc.) of subsystem 107f. It will be understood that the primary network control system 119 is not limited to retrieving read only data when using a preliminary NCB, but may do so using any NCB at any time.

The preliminary NCB may indicate the components that are to be included in the communication network system 100, the assembly or setup of the components, and the configurations of the components. For example, the preliminary NCB may indicate that the communication network system 100 is to include a subsystem 107i (at a remote site), network core (e.g., 5G core, LTE core, etc.), various sensors, etc.

The preliminary NCB may also indicate how the components will be assembled or set up. For example, the preliminary NCB may indicate how the components will be connected (physically and/or communicatively) and whether they will be co-located. For example, the preliminary NCB may indicate that the 5G core will be remotely located in a cloud environment and that one or more sensors will be co-located with the remote site 107i. The preliminary NCB may also indicate that the sensors co-located with the remote site 107i will be communicatively coupled to the RAN via a USB cable or via Bluetooth or Wi-Fi, etc.

In addition, the preliminary NCB may indicate the configurations of the RAN and/or 5G core. For example, the preliminary NCB may indicate that the RAN is to be setup to allow only certain communications from a predefined number of devices, the frequency bands it is to use, and/or that the RAN is to communicate with the 5G core via a particular port. As another example, the preliminary NCB may indicate which version of software is to be used with the 5G core, RAN, and/or other network component. Similarly, the preliminary NCB may identify which user equipment are allowed access to the network via the 5G core, etc. By identifying the network components, their assembly/setup, and configurations, the preliminary NCB can form a kind of snapshot of the communication network system 100 and the network it provides.

As the user assembles the communication network system 100, the primary network control system 119 may confirm that the assembly is proceeding in accordance with the preliminary NCB and/or whether the assembly is deviating from the preliminary NCB. For example, if a user sets up a 5G core instead of a 5G core MEC, the primary network control system 119 may alert the user that an incorrect component has been included in the communication network system 100. As another example, if the NCB indicates the RAN should include three radios, but only one is connected, the primary network control system 119 may alert the user that two radios are missing. Similarly, if a user sets up the RAN to comprise a global positioning system (GPS) component, but the GPS component is inoperable during deployment, the primary network control system 119 may alert the user that GPS component is inoperable and needs to be replaced. As another example, if three particular ports of a switch are used which deviate from the number or particular ports indicated in the preliminary NCB, the primary network control system 119 may alert the user as to the discrepancy.

In certain cases, in response to an alert that the assembly deviates from the preliminary NCB, a user may instruct the primary network control system 119 to update the preliminary NCB based on the current assembly/setup or configuration. In some such cases, the primary network control system 119 may replace the first preliminary NCB with a second preliminary NCB. In some such cases, the primary network control system 119 may delete the first preliminary NCB and/or retain it for rollback purposes. Moreover, the primary network control system 119 may mark the second preliminary NCB as an active NCB and monitor/configure the network components based on the active NCB.

### Primary Network Configuration Baseline

Once the user has assembled and configured the components of the communication network system 100, the primary network control system 119 may create a primary network configuration baseline (primary NCB). The primary NCB may include the similar types of information as the preliminary NCB and may include more or less of it. For example, the primary NCB may identify which ports of a switch are to be used whereas the preliminary NCB may not indicate such detailed hardware setup information (e.g., instead it may merely indicate a quantity of ports that are to be used, etc.). By instantiating or activating a primary NCB, the user may indicate that the network generated by the communication network system 100 is ready for use. As such, the primary network control system 119 may use the primary NCB to monitor and/or manage the communication network system 100, the network it generates, and/or the components thereof during use.

During active use of the network by user equipment, the primary network control system 119 may compare the (current) setup and/or configurations of the network components with the primary NCB. For example, the primary network control system 119 may compare the identities of the UE attached to the network with the UEs identified in the primary NCB as being allowed access to the network. If the setup and/or configurations match the primary NCB, the primary network control system 119 may continue to monitor the network components and/or do nothing. If, however, the setup and/or configurations of the network components do not match the primary NCB, the primary network control system 119 may alert a user as to the deviation. For example, if the primary NCB Indicates that the RAN is to communicate with a 5G core via a particular port (e.g., port 24), but communications are using a different port (e.g., port 12) or communicates with a LTE core, the primary network control system 119 may alert a user that there is a deviation from the primary NCB. Similarly, if the primary NCB indicates that there are to be five ethernet connections in a particular switch, but there are more or less than five, the primary network control system 119 may alert a user that there is a deviation from the primary NCB. As such, the primary network control system 119 and primary NCB may be used to identify errors, malfunctions, and/or flaws in the network generated by or network components of the communication network system 100.

In some cases, the primary network control system 119 may assign logical grouping to the network components of a subsystem 107. The logical grouping may correspond to types of components, geographic locations, etc. For example, the RANs 118 of subsystem 107 may be logically grouped together within an NCB. Similarly, the primary network control system 119 may logically group 5G cores 105b, hardware platforms 103b, or other components of the communication network system 100 and/or subsystem 107. In some cases, the primary network control system 119 may logically group components of a subsystem 107 that are in close proximity (e.g., within a threshold distance, such as 10 ft., within the same room, building, military camp or base, etc.).

Although described in the singular, it will be understood that the primary network control system 119 may store multiple primary NCBs and designate one as the active primary NCB for use in monitoring the components of the communication network system 100 and/or subsystem 107.

### Modifying the Primary Network Configuration Baseline

The primary network control system 119 monitors the network components for alterations in the configurations of the network components. The alterations may be physical alterations or software related alterations that do not reflect the configurations of the primary network configuration baseline. In some instances, the primary network configuration baseline may be used to modify the configurations of the components and/or revert the network components configuration to the primary network configuration baseline. The primary network control system 119 may determine the network configuration of the network components do not match the primary network configuration baseline and generate an alert. The alert may indicate to the primary network control system 119 to revert the network component configuration to the primary network configuration baseline. Additionally, the alert may indicate to the primary network control system 119 to generate a second primary network configuration baseline and monitor the network components with the second primary network configuration baseline.

In some cases, the primary network control system 119 may enable a user to replace the first primary NCB with a second primary NCB. For example, in the event the primary network control system 119 receives an indication that the current setup or configurations of the network components do not match the primary NCB, a user may indicate that the change in network components is expected and should be part of the primary NCB. As another example, a user may modify the primary NCB to indicate that there has been some change to a particular component (e.g., a different port for communications, additional communication link, additional UEs allowed, etc.). In either of the aforementioned examples, the primary network control system 119 may replace the first primary NCB with the second primary NCB and begin comparing the communication network system 100 and components thereof and their configurations with the second primary NCB to determine compliance.

Furthermore, the primary network control system 119 may determine to replace the first primary NCB with the second primary NCB. For example, a change to a particular component may be expected or approved. In some such cases, the primary network control system 119 may generate a second primary NCB that includes the changed configuration for the particular component.

Similar to the first primary NCB, the primary network control system 119 may use the second primary NCB monitor and/or manage the network components. It will be understood that the primary network control system 119 may enable a user to serially create one or many primary NCBs depending on the changing dynamics of the network. Accordingly, as the user makes changes to the network components, the communication network system 100 may replace the second primary NCB with a third primary NCB and so on.

In some cases, if a user makes a change to the primary NCB, the primary network control system 119 can be configured to push any updated configurations to corresponding network components. For example, if the frequency band use for wireless communications is changed in the primary NCB, the primary network control system 119 may communicate instructions to the RAN to change its frequency band usage. Another example, if a user determines that an additional network component is desired, the additional components can be incorporated in another primary NCB using the primary network control system 119 and utilized to configure the additional components and the preexisting components that are part of the network.

In some cases, when replacing a first primary NCB with a second primary NCB, the primary network control system 119 may store the first primary NCB in non-volatile memory for rollback purposes. In some cases, the primary network control system 119 may monitor the network while operating in accordance with the second primary NCB. For example, the primary network control system 119 may monitor network traffic, throughput, network reliability, etc. If the network satisfies a threshold, the primary network control system 119 may automatically replace the second primary NCB with the first primary NCB (e.g., revert to using the primary NCB). The thresholds used to decide whether to revert to the first primary NCB may include, but are not limited to, network failure (e.g., inability of the network to communicate messages between components), component failure (e.g., inability to communicate with a component of the system), packet loss (e.g., number of packets below a threshold), network speed, number of network components with active network connectivity, etc. As another example, the use of the second primary NCB may be for a testing period, when the testing period ends the second primary NCB is to be replaced with the first primary NCB.

In some cases, the primary network control system 119 may partially revert to the first primary NCB. For example, the second primary NCB may include different software configurations and hardware configurations. In some such cases, the primary network control system 119 may revert to the software configurations of the first primary NCB while retaining the hardware configurations of the second primary NCB (or vice versa). As a non-limiting example, consider a scenario in which software used by one or more components of the system are updated to a new version and certain hardware configurations are changed (e.g., a different port of a router is used). In some such cases, upon satisfying a threshold, the primary network control system 119 may revert some or all of the software to earlier versions (e.g., the versions from the first primary NCB) while retaining the hardware configuration (e.g., retaining the different port used for the router).

In some cases, the primary network control system 119 determines a network outage in a remote data center affecting operation of the communication network system 100. The primary network control system 119 may use machine learning to detect unauthorized configuration changes in the network components, such as routers 109 and switches 108. The primary network control system 119 may isolate the compromised network component and revert the network components configuration to a primary NCB. Additionally, the primary network control system 119 may update the network components firmware before reverting the network components configuration to the primary NCB. The primary network control system 119 can quickly resolve the issues with network components minimizing downtime and further ensuring network stability.

In some cases, the primary network control system 119 may determine the platforms 102 are experiencing intermittent failures due to power voltage fluctuations. The primary network control system 119 may use machine learning to detect abnormal voltage patterns on the platforms 102 based on historical data of voltage fluctuations. The primary network control system 119, using the machine learning model may analyze the voltage patterns of the network components and identify the voltage pattern is abnormal behavior for the network component. The primary network control system 119 can isolate a corresponding faulty power supply unit and perform a power adjustment about the power distribution to stabilize the voltage. The primary network control system 119 may, using machine learning model, predict optimal adjustments needed to normalize the voltage by turning off non-critical components, switching over to a backup power supply, or redistributing power from other network components. Additionally, the primary network control system 119 may notify a user that may be located locally to platform 102 for immediate inspection and physical repair. The primary network control system 119 can quickly resolve the issues with power stability with network components minimizing downtime and further ensuring network stability.

### Merging Subsystems or Networks

In certain cases, the primary network control system 119 may be used to merge communication network systems 100. and/or NCBs. For example, if a first secondary network control system 101 (and corresponding network) with its own NCB is to be combined with a second secondary network control system 101 (and its corresponding network) with its own NCB, the primary network control system 119 can facilitate the combining of the secondary network control systems 101, subsystems 107 (and corresponding networks) and NCBs. For example, the primary network control system 119 may modify one of the NCBs from one of the secondary network control system 101 to include the information from the other NCB and/or the primary network control system 119 may create a new NCB that includes some or all of the information from the two NCBs.

In combining the NCBs, the primary network control system 119 may identify conflicting configurations and generate an alert indicating that before combining the communication network systems 100 (and corresponding networks) one or more configurations should be changed. For example, the primary network control system 119 may determine that different and/or conflicting versions of software or firmware are being used by network components of the communication network systems 100 that are to be merged and generate an alert that the same versions should be used and/or automatically modify the configurations of one or both of the communication network system 100 to use the same version of software for a particular component. In some cases, this may include rolling back a software version on a component of one of the communication network systems 100 to an earlier version and/or updating the software on a component of one of the communication network systems 100.

As another example, the communication network systems 100 may operate on different frequency bands. When merging the communication network systems 100 into a single communication network system 100, the primary network control system 119 may modify the configuration of one or both of the communication network system 100 to operate on the same frequency band. In certain cases, the communication network systems 100 may use different hardware or software ports. To the extent the use of a particular hardware or software port creates a network error or problem, the primary network control system 119 can indicate that the port should be changed and/or automatically modify the (software) port of one or both communication network systems 100.

In some cases, the primary network control system 119 may generate a preliminary NCB from two primary NCBs and enable a user to set up and configure the new (larger) communication network system 100. Once set up and configured, the primary network control system 119 may enable the user to generate a primary NCB for the new communication network system 100. In some cases, the primary network control system 119 may store the NCBs from the former networks for backup and/or rollback purposes. For example, the communication network system 100 (and corresponding networks) may be combined for a particular period of time. After the particular period of time, the primary network control system 119 may use the NCBs from the former communication network system 100 to recreate the former subsystems 107, etc.

In some cases, multiple communication network system 100 may be combined to form a larger communication network system 100 with multiple subsystems 107. In some such cases, the communication network systems 100 used to form the larger communication network system 100 may become respective subsystems 107 of the larger communication network system 100. For example, consider a scenario in which a first communication network system 100 is to be combined with a second communication network system 100 to form a third communication network system 100 in which the first communication network system 100 and the second communication network system 100 become a first subsystem 107 and second subsystem 107 of the third communication network system 100. In such a scenario, the NCBs of the first communication network system 100 and second communication network system 100 may become the NCBs of the first subsystem 107 and the second subsystem 107, respectively. Moreover, a third NCB for the third communication network system 100 may be formed that indicates that there are two subsystems 107 and includes the components and configurations of the two subsystems 107.

When combining the communication network systems 100 into subsystems 107 of a larger communication network system 100, the primary network control system 119 may identify conflicting configurations between the subsystems 107. and generate an alert and/or automatically modify the configurations of one or more software or hardware components of one or more subsystems 107. For example, the primary network control system 119 may determine that the subsystem 107 is operating on the same frequency band, which could cause network interference and modify one or both of the subsystems 107 to operate on a different frequency band. Similarly, the subsystems 107 may use the same hardware or software ports for certain communications, which may conflict. In some such cases, the primary network control system 119 can indicate that the port should be changed and/or automatically modify the (software) port of one or both subsystems 107.

### Splitting a Subsystem or Network

In some cases, the primary network control system 119 may enable a user to split a communication network system 100 into multiple communication network systems 100 and/or split a primary NCB into multiple primary NCBs (or preliminary NCBs). For example, as mentioned above, it may be desirable to combine communication network system 100 (and corresponding networks) for a period of time (e.g., when the users of those networks are geographically proximate) and then split the communication network system 100 (and corresponding networks) after the period of time (e.g., when the users of those networks are no longer proximate). As another example, it may be desirable to split one or more subsystems 107 or subnetworks of a communication network system 100 into separate subsystems 107 or networks. In some such cases, the primary network control system 119 may split the primary NCB of a subsystem 107 into multiple primary NCBs (or preliminary NCBs) for respective subsystems 107.

In splitting the primary NCB into multiple NCBs, the primary network control system 119 may provide recommendations for splitting the communication network system 100 or subsystem 107. Such recommendations may be based on logical groupings and/or the geographic location of network components, previous or pre-existing relationships between components (e.g., components that were previously part of the same communication network system 100), etc. In some cases, the primary network control system 119 may generate preliminary NCBs that indicate a particular number or types of components that would be required to create a working network. As the user selects which components are to be part of which communication network system 100, the primary network control system 119 can generate alerts if the assigned components are insufficient to create a working network.

The primary network control system 119 may be used to identify potentially conflicting configurations of the to-be-separate communication network systems 100 or subsystems 107. For example, while part of the same communication network system 100, the components may operate on the same frequency band. Once separated, it may be desirable to have the separate communication network system 100 or subsystem 107 operate on distinct frequency bands. In some such cases, the primary network control system 119 may indicate what change should be made or automatically modify the configurations of one or both communication network systems 100 and subsystems 107 to operate on different frequency bands. Similarly, the primary network control system 119 may identify other potentially conflicting configurations (e.g., hardware and/or software ports, etc.) and generate an alert to modify or automatically modify the respective configurations.

Once a user selects the different components for the different communication network systems 100 or subsystems 107, the corresponding NCBs may be used to assemble, setup, and configure the new communication network systems 100 or subsystems 107. Once configured, the corresponding primary NCBs may be used to monitor the network components of the corresponding communication network systems 100 or subsystems 107. It will be understood that many variations of merging networks or splitting a network, communication network system 100 or subsystem 107 may be used.

The primary network control system 119 may also be configured to retrieve data from the network components and use the data to identify issues with the components of or network generated by the communication network system 100. For example, the primary network control system 119 may include a machine learning model that generates behavior profiles for the network components or network, and identifies aberrations, deviations, errors, etc. In yet another example the primary network control system 119 may include a machine learning model that optimizes the network configurations as a result of self-healing. Furthermore, the machine learning model can be trained using key performance indicators to then analyze and determine future component failures and/or configuration changes that have occurred as a result of an intervention. Furthermore, a machine learning model can be utilized to operate the primary network control system 119 completely independent from a user interaction or utilize a human-in-the-loop strategy for a user to interact with the primary network control system 119 when it is required.

The data collected from the network components may also be utilized to optimize the configurations within a corresponding NCB. For example, using the data collected from the network components, the primary network control system 119 may determine that one or more configurations in one or more network components creates bottlenecks or other issues. Accordingly, the primary network control system 119 may make one or more recommendations to improve the functionality or utilization of the network components.

### Secondary Network Control Systems

As described herein, a network may include one or more subnetworks or subsystems 107 configured by a user. While the primary network control system 119 may be configured to monitor some or all of the network components of the communication network system 100, it may be desirable to selectively monitor components of a particular subnetwork or subsystem 107. For example, with continued reference to the merging of two communication network systems 100 (and corresponding networks), it may be desirable to separately monitor the components of the previous two communication network systems 100 even after they are merged into a single communication network system 100. Such monitoring may enable different users to focus on different subnetworks and/or facilitate the splitting of a communication network system 100 or network into multiple communication network systems 100 or networks, etc.

In some cases one or more subsystems 107 or subsets of components of the network may be associated with a respective secondary network control system 101. The secondary network control system 101 for a particular subsystem 107 may perform some or all of the functions for the components of subsystem 107 that the primary network control system 119 performs for the components of the communication network system 100. Thus, in some cases, the secondary network control system 101 may be functionally the same or similar to the primary network control system 119, except that the secondary network control system 101 may provide monitoring and/or managing of the individual components of a particular subsystem 107. Moreover, in some such cases, a subsystem 107 may not have awareness or data, or otherwise track, components of another subsystem 107. As such, in certain cases, a secondary network control system 101 may identify, monitor, and make adjustments to only components of its respective subsystem 107 or network.

In some cases, the secondary network control system 101 may include a system (or subsystem) configuration baseline (SCB) for the components of the respective subsystem 107. The SCB may include information similar to that of an NCB but limited to the components of the respective subsystem 107. For example, an SCB may include identifiers for the components of the subsystem 107 and indicate how the components of the subsystem 107 are assembled/setup and configured, etc.

In addition, the secondary network control system 101 may use the SCB to monitor the setup and configurations of the components of the subsystem 107, generate alerts, etc. In addition, the secondary network control system 101 may enable a user to make changes to the components of the SCB (e.g., add/remove components, change the physical setup, change the configurations, etc.) and generate a second SCB (e.g., a second primary SCB), third SCB, etc. For example, a secondary network control system 101 may indicate to a user an error has occurred within a particular subsystem 107. As described herein with respect to the NCB, a user may address the alert by adjusting a setup or configuration to comply with the SCB and/or generate a new primary SCB.

The secondary network control systems 101 may monitor and/or manage respective components of the subsystems 107. In some cases, a user may use the secondary network control systems 101 to monitor and/or manage the components of a respective subsystem 107 (independent of the primary network control system 119). The secondary network control system 101 may also retrieve data from the plurality of components within the subsystem 107, analyze the data using one or more machine learning models, and generate alerts, etc., as described herein with respect to the primary network control system 119. In certain cases, the secondary network control systems 101 may communicate relevant data to the primary network control system 119, and a user may use the primary network control system 119 to monitor and/or manage the components of the various subsystems 107.

The secondary network control systems 101 may operate independently from each other and/or independent of the primary network control system 119. For example, the secondary network control systems 101 may not communicate, receive instructions from, and/or send instructions to another 101 and/or the primary network control system 119. Moreover, the secondary network control systems 101 may be mobile with the corresponding subsystems 107. For example, the secondary network control system 101 may provide the aforementioned functionality as it or the corresponding subsystem 107 (or subnetwork) is moving.

In certain cases, the secondary network control systems 101 may communicate with the primary network control system 119. For example, individual users may use secondary network control systems 101 to create individual SCBs for particular subsystems 107. The secondary network control systems 101 for the respective subsystems 107 may communicate their respective SCBs to the primary network control system 119. The primary network control system 119 may use the respective SCBs to form an NCB. Moreover, as changes are made to a particular SCB using a corresponding secondary network control system 101, the secondary network control system 101 may provide an updated SCB to the primary network control system 119.

In certain cases, the secondary network control systems 101 may communicate some or all of the data that they receive from the components of their respective subsystems 107 to the primary network control system 119. As such, the primary network control system 119 may have visibility into all of the components of all of the subsystems 107 of the communication network system 100. In certain cases, the secondary network control systems 101 of a communication network system 100 independently provide reports and/or access to their respective components to a user. In some cases, the secondary network control system 101 does not independently provide reports and/or access to their respective components to a user. In some such cases, the primary network control system 119 may provide reports and/or access to the components of the respective subsystems 107 and corresponding secondary network control systems 101.

In some cases in which one or more subsystems 107 include respective secondary network control systems 101 and SCBs, some components of the network may not correspond to a particular secondary network control system 101 and/or be included in a particular SCB. As such, the NCB may include the data from some or all of the SCBs in the network as well as the setup and configurations of the network components that are not part of a subsystem 107 and/or SCB.

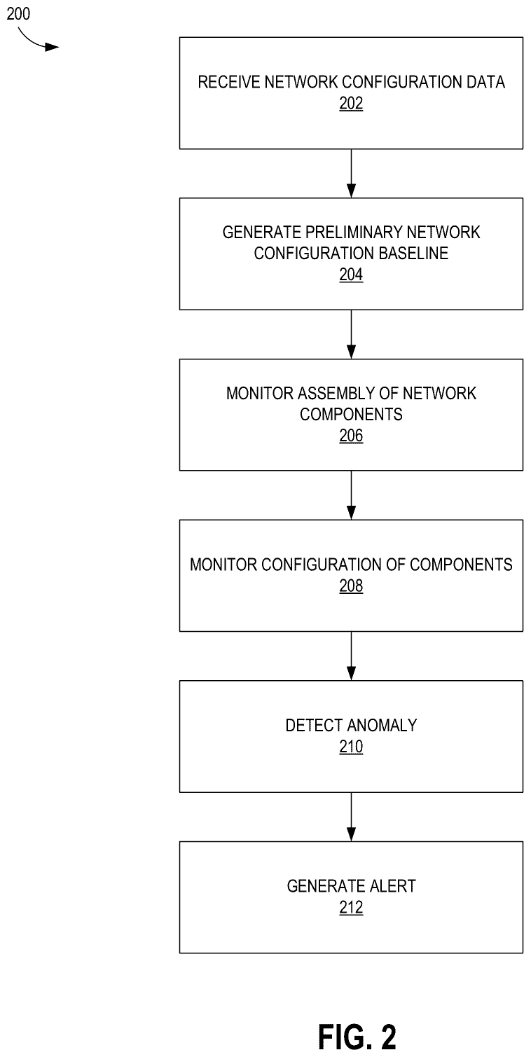

FIG. 2 is a flow diagram illustrative of an embodiment of a routine 200 implemented for configuring a primary network configuration baseline. One skilled in the relevant art will appreciate that the elements outline for routine 200 may be implemented by one or more computing devices/components that are associated with configuring a preliminary network configuration baseline. Accordingly, routine 200 has been logically associated as being generally performed by the primary network control system 119. Although described herein as being implemented by a primary network control system 119 on a communication network system 100, it will be understood that the functionality described herein may be implemented by a secondary network control system 101 on a subsystems 107, and thus the following illustrative embodiments should not be construed as limiting.

At block 202, the primary network control system 119 receives a network configuration data. As described herein, the network configuration data may correspond to and include configurations and/or software versions for components of the communication network system 100 (or subsystems 107).

At block 204, the primary network control system 119 generates a preliminary network configuration baseline. As described herein the preliminary network configuration baseline may be used prior to activation of the communication network system 100. As described herein, the preliminary network configuration baseline may identify the components of the communication network system 100 and/or subsystems 107 as well as the configurations and/or software versions thereof. For example, the preliminary network configuration baseline may indicate the number of routers and/or switches for the communication network system 100 and identify which ports of the routers and/or switches are to be used, and which cables are to plug into which ports.

At block 206, the primary network control system 119 monitors the assembly of the communication network system 100 using the preliminary network configuration baseline. As described herein, the primary network control system 119 can monitor whether the components of the communication network system 100 are being assembled and connected in accordance with the preliminary network configuration baseline.

At block 208, the primary network control system 119 monitors the configuration of the components of the communication network system 100. For example, the primary network control system 119 can identify the configurations and/or software version of the components as they are connected to or become part of the communication network system 100.

At block 210, the primary network control system 119 detects an anomaly. As described herein, the primary network control system 119 can determine that a configuration or software version of a component or the connection of two components is different from a corresponding configuration, software version, or connection, respectively, in the preliminary network configuration baseline. For example, the primary network control system 119 may determine that the ports used for a particular router are different from what is identified in the preliminary network configuration baseline. As such, the primary network control system 119 can determine an anomaly with the setup of the communication network system 100.

At block 212, the primary network control system 119 can generate an alert. The alert may indicate the connection, configuration or software version that deviates from the preliminary network configuration baseline. Based on the alert, corrective action may be taken. In some cases, the configuration and/or connection may be changed in accordance with the preliminary network configuration baseline. In certain cases, the preliminary network configuration baseline may updated to reflect the change.

Depending on the embodiment, certain acts, events, blocks, or functions of any of the routine 200 can be performed in a different sequence, can be added, merged, or left out altogether (non-limiting example: not all described operations or events are necessary for the practice of the routine 200). For example, in some embodiment, any one or any combination of the aforementioned blocks, can be omitted. Moreover, in certain embodiments, operations or events can be performed concurrently, e.g., through multi-threaded processing, interrupt processing, or multiple processors or processor cores or on other parallel architectures, rather than sequentially.

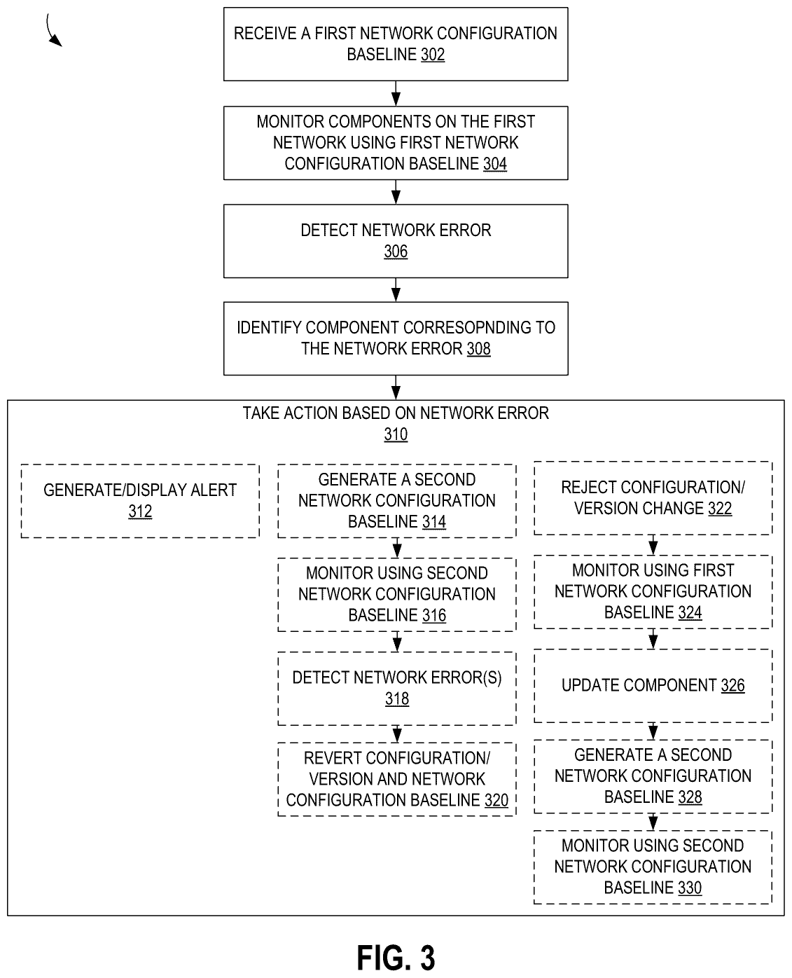

FIG. 3 is a flow diagram illustrating an example of an embodiment of a routine 300 for monitoring a cellular network system. One skilled in the relevant art will appreciate that the elements outlined for routine 300 may be implemented by one or more computing devices/components of the communication network system 100. Accordingly, routine 300 has been logically associated as being generally performed by the primary network control system 119. Although described herein as being implemented by a primary network control system 119 on a communication network system 100, it will be understood that the functionality described herein may be implemented by a secondary network control system 101 on a subsystems 107, and thus the following illustrative embodiments should not be construed as limiting.

At block 302, the primary network control system 119 receives a first network configuration baseline. As described herein, the first network configuration baseline may identify components of the primary network control system 119 and configurations/versions for those components. As described herein, the components may include hardware components, such as but not limited to, network servers, network routers, network switches, 5G cores, baseband units, and/or radio units, and/or software components. Similarly, the configurations or versions for the components may include hardware configurations, software configurations, software versions, etc.

Non-limiting examples of hardware configuration include, but are not limited to, port usage; CPU and memory allocations, such as SCB, base stations, and/or software components; network slices setup/size for different network services (e.g., video streaming, IOT devices, etc; antenna angles, power output, and signal strength; handover parameters for handing over UE between base stations or network cells; network routing protocols; electrical power balancing across nodes; cellular standard used (e.g., 5G, LTE, 3G, etc.); etc.

At block 304, the primary network control system 119 monitors the components of the cellular network based on the first network configuration baseline. As part of monitoring the components of the cellular network, the primary network control system 119 may collect metrics, log data, and/or network traffic data from some or all of the components of the communication network system 100. In some cases, the primary network control system 119 may collect different information depending on the type of component of the communication network system 100. In certain cases, the metrics, log data, traffic data, or other data collected by the primary network control system 119 may include configurations and/or settings of the respective components. Non-limiting examples of different configurations for different components are describe herein.

As a non-limiting example, for a server, the primary network control system 119 may collect the following metrics: CPU utilization, memory usage, disk I/O rates, network bandwidth usage, latency, and response times; the following log data: system logs, application logs, security logs, and performance logs; and the following network traffic data: inbound/outbound network traffic volumes, number of network connections and durations, network packet loss, and application-specific traffic patterns.

As a non-limiting example, for a network router, the primary network control system 119 may collect the following metrics: packet forwarding rates, network interface statistics, routing table information, latency, and jitter; the following log data: routing updates, interface status logs, security logs, and event logs; and the following network traffic data: traffic volumes per interface, source/destination IP statistics, protocol distribution, and QoS enforcement statistics.

As a non-limiting example, for a network switch, the primary network control system 119 may collect the following metrics: port utilization rates, error rates, MAC address table changes, latency, and jitter; the following log data: port status logs, VLAN configuration changes, security logs, and event logs; and the following network traffic data: traffic volumes per port, VLAN traffic statistics, packet forwarding rates, and STP events.

As a non-limiting example, for a 5G core (or other cellular network core), the primary network control system 119 may collect the following metrics: session establishment success rates, user data throughput, control plane latency, CPU, and memory usage; the following log data: session management logs, mobility management logs, authentication/security logs, and system performance logs; and the following network traffic data: subscriber data flows, control plane signaling flows, interconnect traffic, and QoS policy enforcement.

As a non-limiting example, for a baseband unit (BBU) or other radio unit, the primary network control system 119 may collect the following metrics: signal quality indicators (SINR, RSSI), bandwidth usage, CPU, and memory utilization, latency, and jitter; the following log data: radio resource management logs, system performance logs, error logs, and security logs; and the following network traffic data: user data traffic, control signaling traffic, handover statistics, and traffic per frequency band.

As a non-limiting example, for a radio unit (RU) or other, the primary network control system 119 may collect the following metrics: transmission power levels, signal quality indicators, uplink/downlink throughput, and interference levels; the following log data: transmission logs, system performance logs, error logs, and security logs; and the following network traffic data: user data traffic, control signaling traffic, traffic per cell, and handover statistics.

At block 306, the primary network control system 119, determines at least one network error based on the monitoring and at block 308, the primary network control system 119 identifies the component corresponding to the network error.

As described herein, the network configuration baseline and/or the primary network control system 119 may include a respective threshold for some or all of the metrics, log data, and/or network traffic data collected from some or all of the components. For example, for each server, the network configuration baseline and/or primary network control system 119 may include a CPU utilization threshold, memory usage threshold, disk I/O rate thresholds, network bandwidth usage threshold, latency threshold, and response times threshold. inbound/outbound network traffic volumes threshold, number of network connections threshold and durations threshold, network packet loss threshold, and application-specific traffic patterns threshold, login attempts threshold, etc. Similarly, the primary network control system 119 may identify configuration changes to the server and/or software operating on the server based on the log data or include threshold for the amount and/or type of log data.

In a similar fashion, the primary network control system 119 and/or network configuration baseline may include respective thresholds for some or all of the metrics, log data, and/or network traffic data collected from the routers, switches, 5G cores, baseband units, and/or radio units of the communication network system 100. Similarly, the primary network control system 119 may identify configuration changes to the routers, switches, 5G cores, baseband units, and/or radio units of the communication network system 100 and/or software operating on the respective components based on the log data or include thresholds for the amount and/or type of log data.

In some cases, the primary network control system 119 may determine a network error has occurred based on the satisfaction of one or more thresholds and/or the identification of a configuration change. For example, the primary network control system 119 may determine a network error based on one or more detected configuration changes to any one or any combination of a server, router, switch, 5G core, baseband unit, and/or radio unit of the communication network system 100. As described herein, each component may have many different configurations. The primary network control system 119 may determine that a change to any one or any combination of the configurations of any one or any combination of components may be considered a network error. As another example, the primary network control system 119 may determine a network error based on a metric, log data, or network traffic data collected from a server, router, switch, 5G core, baseband unit, and/or radio unit, or other component of the communication network system 100, satisfying a corresponding threshold.

In certain cases, the primary network control system 119 may determine a network error based on a combination of thresholds, combination of configuration changes and/or based on a deviation from a pattern. As described herein, the primary network control system 119 may use one or more trained machine learning models to identify patterns and deviations from patterns in the data collected form the components of the communication network system 100 or deviations from patterns in configuration changes. The machine learning models may be trained in an unsupervised fashion (e.g., using clustering (e.g., K-means) and/or Principal Component Analysis (PCA), etc.) based on data collected from the components of the communication network system 100.

In certain cases, the primary network control system 119 may include a trained machine learning model for each type of component of the communication network system 100. In some such cases, each machine learning model may be trained on data from the respective component. For example, one machine learning model may be trained on metrics, log data, and network traffic data of a server, another machine learning model may be trained on metrics, log data, and network traffic data of a 5G core, and so one. As such, the primary network control system 119 may include a machine learning model for each type of component analyzed. In certain cases, the primary network control system 119 may include a machine learning model trained using all the data collected from all of the components of the communication network system 100.

As described herein, the machine learning models may be trained to identify patterns and normal ranges of behavior of the respective components (or combinations thereof) and generate a network error when the metrics, log data, and/or network traffic data deviate from the pattern and/or normal ranges. In certain cases, the machine learning models may provide a probability that certain data deviates from an identified pattern or normal range. The primary network control system 119 may use a threshold probability to determine that the specified data constitutes a network error. For example, the primary network control system 119 may determine a network error based on determination that a determined probability satisfies a threshold probability.

At block 310, the primary network control system 119 takes an action based on the network error. In some cases, the action may include any one or any combination of: generating/displaying an alert for a user (312) (e.g., via a graphical user interface such as a dashboard, phone call, text message, etc.), creating a new (second) network configuration baseline (314) and using the second network configuration baseline to monitor the communication network system 100 (316), rejecting a changed configuration associated with the network error (322) and modifying the configuration of a hardware or software component affected by the network error, modifying a software version of a software component, etc.

In some cases, the primary network control system 119 may determine that the network error corresponds to a changed configuration of a hardware or software component by comparing the configurations of the hardware or software component with corresponding configurations for the hardware or software component in the first network configuration baseline and determining that at least one configuration of the hardware or software component does not match a corresponding configuration for the hardware or software component in the first network configuration baseline.

Based on the determination that a particular configuration of the hardware or software component has changed, the primary network control system 119 may decide to: accept the configuration change or reject the configuration change.

In some cases, the primary network control system 119 decides to accept the configuration change. For example, the primary network control system 119 may determine that the changed configuration is an acceptable change (e.g., a change made by an authorized user, machine learning model, etc.). Based on a determination to accept the change, the primary network control system 119 may generate a new (second) network configuration baseline that includes the changed configuration for the hardware or software component (314). The primary network control system 119 may use the second network configuration baseline to monitor the components of the communication network system 100 (316).

In some cases, if the primary network control system 119 detects networks errors associated with (e.g., attributed to) the component with the changed configuration (of the second network configuration baseline) (318), the primary network control system 119 may revert the configuration to the previous configuration setting, and revert the changes in the second network configuration baseline back to the first network configuration baseline (or to a third network configuration baseline that includes the previous configuration setting in the event other configurations of other components have been changed since the second network configuration baseline was implemented) (320), and use the first network configuration baseline to monitor the communication network system 100.

In certain cases, the primary network control system 119 decides to reject the configuration change (322). For example, the primary network control system 119 may determine that the changed configuration was not authorized (e.g., not made by an authorized user). In some such cases, the primary network control system 119 may modify the changed configuration of the hardware or software component to revert to the configuration as found in the first network configuration baseline, and use the first network configuration baseline to continue to monitor the communication network system 100 (324). In certain cases, after rejecting the configuration change (and to prevent future unauthorized configuration changes), the primary network control system 119 may check for firmware or other updates for the component, update the component based on the identified updates (e.g., update the firmware) (326), generate a new (second) network configuration baseline based on the updated component (328), and use the second network configuration baseline to monitor the components of the communication network system 100 (330).

In a manner similar to the handling of a changed configuration, the primary network control system 119 may determine that the network error corresponds to a changed software version of a software component. As described above with regard to a changed software configuration, the primary network control system 119 may accept or reject the changed software version. If accepted, the primary network control system 119 may generate a new (second) network configuration baseline that includes the changed (or new) software version for the software component (314) and use the second network configuration baseline to monitor the components of the communication network system 100 (316). If network errors appear that are attributed to the component that had the new software version installed (318), the primary network control system 119 may revert to the previous software version and revert the second network configuration baseline to the first network configuration baseline (or change to a third network configuration baseline as described) (320) and use the first (or third) network configuration baseline to monitor the components of the communication network system 100. If rejected, the primary network control system 119 may revert to an earlier software version or the software version that is found in the first network configuration baseline (322) and monitor the communication network system 100 using the first network configuration baseline (324).

As described herein, in some cases, the action taken by the primary network control system 119 may depend on the affected component. For example, if the component associated with the identified error (e.g., the component with the configuration that has changes) is a hardware component, the primary network control system 119 may adjust the configuration of the hardware component. If the component is a software component, the primary network control system 119 may adjust the configuration of the software component and/or software version of the software component.

It will be understood that any one or any combination of the aforementioned actions may be taken. For example, the primary network control system 119 may generate/display an alert (312) and/or revert a configuration, software version, and/or network configuration baseline (320) in response to detecting a network error(s) (318) in combination with any of the other actions that may be taken, such as after monitoring the system using the second network configuration baseline (330).

In certain cases, the primary network control system 119 may use a trained machine learning model to determine the action to take for a respective network error. The trained machine learning model may be trained using supervised learning (e.g., using like Random Forest, Support Vector Machines (SVM), etc.). The training data may include configuration data obtained from other communication network system 100 and network configuration baselines of other communication network system 100. Synthetic configurations and data may also be used to train the machine learning model. Optimized configurations, best practices, and network configuration manuals may also be used as training data. The trained machine learning model may make hardware and/or software configuration changes based on the network error.

As described herein, following an action, the primary network control system 119 may continue to monitor the communication network system 100. As described herein, the primary network control system 119 may continue to monitor the communication network system 100 using the first network configuration baseline or a second network configuration baseline that includes a changed hardware or software configuration of a respective hardware or software component or a changed software version for a software component.

If the primary network control system 119 uses a second network configuration baseline to monitor the communication network system 100 and detects network errors associated with the modified component (e.g., hardware or software component that includes a modified configuration and/or changed software version), the primary network control system 119 may revert the modified configuration or software version to the previous configuration or software version and/or revert to the previous (first) network configuration baseline.

As a first non-limiting example, consider a scenario in which the primary network control system 119 determines a network error corresponds to a voltage error (e.g., detects an abnormal voltage, such as a voltage that satisfies a voltage threshold, or abnormal voltage pattern, such as a voltage pattern that deviates from a determined voltage range or voltage pattern) for a particular hardware component (e.g., a server experiences intermittent failures due to power voltage fluctuations). Based on the identification of the hardware component and voltage error, the primary network control system 119 may identify a power supply unit associated with the hardware component, and adjust the power distribution to stabilize the voltage. In some cases, the primary network control system 119 may adjust the power distribution (e.g., redistribute power) by, for example, turning off non-critical hardware components of the communication network system 100 or non-critical subcomponents of the affected hardware component, switching to a backup power supply, and/or redistributing power from other power supply units. In certain cases, the primary network control system 119 may also generate an alert identifying the faulty power supply unit. In some cases, the primary network control system 119 may generate a new (second) network configuration baseline that includes the changes to the communication network system 100 (e.g., the deactivated components or subcomponents, the backup power supply being used, redistributed power settings, etc.).

As another non-limiting example, consider a scenario in which the primary network control system 119 determines a network error corresponds unauthorized configuration changes to a hardware or software component of the communication network system 100 (e.g., a network switch). As described herein, the primary network control system 119 may identify the unauthorized configuration changes by comparing the changed configuration with a corresponding configuration in the first network configuration baseline and/or using a trained machine learning model trained to identify patterns of configuration changes that are unauthorized.

Based on the identification of the affected hardware component, the primary network control system 119 may reject the configuration change and revert the configuration of the affected hardware component to the configuration found in the first network configuration baseline. In some such cases, the primary network control system 119 may continue to monitor the communication network system 100 using the first network configuration baseline.

In some cases, the primary network control system 119 may attempt to prevent future unauthorized configurations by checking for and updating the firmware of the hardware component, and updating the first network configuration baseline to reflect the updated firmware (e.g., by generating a new (second) network configuration baseline that includes the updated firmware for the affected hardware component). In some such cases, the primary network control system 119 may monitor the communication network system 100 using the second network configuration baseline.

In certain cases, based on the identification of the affected hardware component and network error, the primary network control system 119 may accept the configuration change and generate a new (second) network configuration baseline that includes the changed configuration for the affected hardware component. In some such cases, the primary network control system 119 may monitor the communication network system 100 using the second network configuration baseline. If the primary network control system 119 detects a network error associated with the same hardware component and/or the changed configuration (e.g., network throughput errors, packet dropped errors, etc.), the primary network control system 119 may revert the changed configuration to the previous configuration and revert the second network configuration baseline to the first network configuration baseline.

Depending on the embodiment, certain acts, events, blocks, or functions of any of the routine 300 can be performed in a different sequence, can be added, merged, or left out altogether (non-limiting example: not all described operations or events are necessary for the practice of the routine 300). For example, in some embodiment, any one or any combination of blocks, can be omitted, such that the primary network control system 119 monitors and reverts network configuration baseline without generating an alert. Moreover, in certain embodiments, operations or events can be performed concurrently, e.g., through multi-threaded processing, interrupt processing, or multiple processors or processor cores or on other parallel architectures, rather than sequentially. Although described herein as being performed on a cellular network system, it will be understood that the system and methods described herein may be used for other network systems, such as, but not limited to, Wi-Fi network systems, etc.

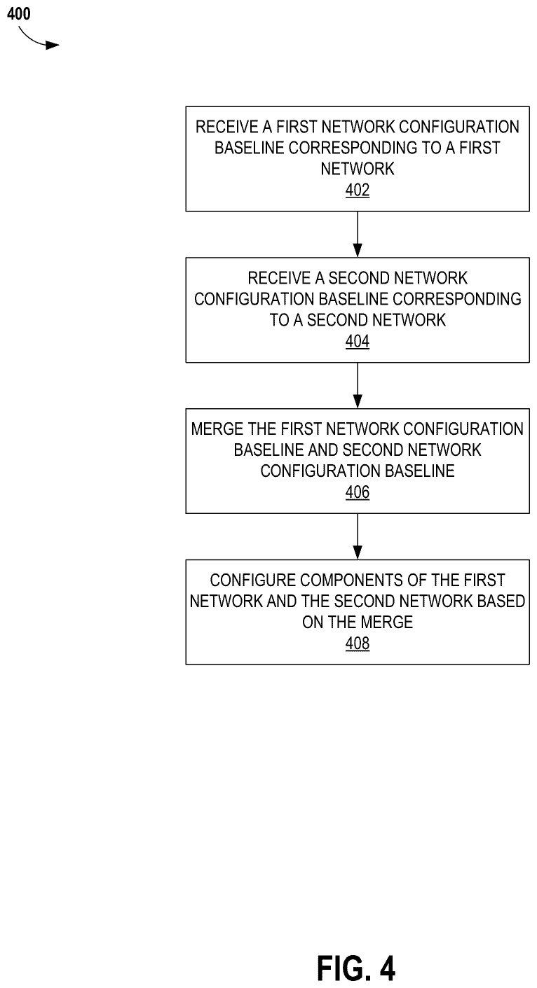

FIG. 4 is a flow diagram illustrative of an embodiment of a routine 400 implemented for configuring a machine learning monitoring component. One skilled in the relevant art will appreciate that the elements outline for routine 400 may be implemented by one or more computing devices/components that are associated with configuring a machine learning monitoring component. Accordingly, routine 400 has been logically associated as being generally performed by the primary network control system 119. Although described herein as being implemented by a primary network control system 119 on a communication network system 100, it will be understood that the functionality described herein may be implemented by a secondary network control system 101 on a subsystems 107, and thus the following illustrative embodiments should not be construed as limiting.

At block 402, the primary network control system 119 receives a first network configuration baseline corresponding to a first communication network system 100. As described herein, the first network configuration baseline may identify the components of the first communication network system 100 (or subsystems 107), as well as the configuration and/or software versions thereof.

At block 404, the primary network control system 119 receives a second network configuration baseline corresponding to a second communication network system 100. As described herein, the second network configuration baseline may identify the components of the second communication network system 100 (or subsystems 107), as well as the configuration and/or software versions thereof.

At block 406, the primary network control system 119 merges the first NCB and the second NCB. In some cases, the primary network control system 119 merges the first NCB with the second NCB by identifying the first NCB as a first secondary NCB and identifying the second NCB as a second secondary NCB, and including the first secondary NCB and the second secondary NCB as part of a primary NCB. In some such cases, the first communication network system 100 and second communication network system 100 can become a first subsystems 107 and second subsystems 107 of a single communication network system 100.

In certain cases, the primary network control system 119 merges the first NCB and the second NCB by forming a single NCB (either primary or secondary NCB) from the first NCB and the second NCB. In some such cases, the primary network control system 119.

In some cases, as part of merging the first NCB and the second NCB, the primary network control system 119 can confirm whether any of the components of the first NCB or the second NCB including configurations that conflict with each other. For example, the first NCB may be configured to operate on different basebands or using different protocols. In some such cases, the primary network control system 119 can modify the configurations for the components of the first NCB and the second NCB in the new NCB to reduce or eliminate conflicts.

At block 408, the primary network control system 119 configures the components of the merged communication network system 100 in accordance with the merged NCB. As described herein, the primary network control system 119 may modify one or more configurations of one or more components of the merged communication network system 100 to enable the components to work together as part of one communication network system 100.

Depending on the embodiment, certain acts, events, blocks, or functions of any of the routine 400 can be performed in a different sequence, can be added, merged, or left out altogether (non-limiting example: not all described operations or events are necessary for the practice of the routine 400). For example, in some embodiment, any one or any combination of the aforementioned blocks can be omitted. Moreover, in certain embodiments, operations or events can be performed concurrently, e.g., through multi-threaded processing, interrupt processing, or multiple processors or processor cores or on other parallel architectures, rather than sequentially.

### Non-Limiting Example Embodiments

Various example embodiments of the disclosure can be described in view of the following clauses:
Clause 1. A method, comprising:
   receiving a first network configuration baseline of a cellular network system, the first network configuration baseline identifying a plurality of configurations of a plurality of components of the cellular network system,
   wherein the plurality of components comprises a plurality of hardware components and a plurality of software components,
   wherein the plurality of configurations comprise a plurality of hardware configurations for the plurality of hardware components and a plurality of software configurations for the plurality of software components of the cellular network system;
   monitoring the plurality of hardware components and the plurality of software components using the first network configuration baseline;
   determining at least one network error based at least in part on the monitoring;
   identifying at least one hardware component of the plurality of hardware components corresponding to the at least one network error;
   identifying at least one configuration of the at least one hardware component that is different from a corresponding configuration of the at least one hardware component in the first network configuration baseline;
   identifying, using a trained machine learning model, a plurality of possible configurations for the at least one hardware component to address the at least one network error;
   selecting, using a trained machine learning model, at least one configuration from the plurality of possible configurations for the at least one hardware component;
   modifying the at least one hardware component in accordance with the selected at least one configuration;
   generating a second network configuration baseline for the cellular network system based at least in part on the modifying the at least one hardware component in accordance with the at least one configuration; and
   monitoring the plurality of hardware components and the plurality of software components using the second network configuration baseline.
Clause 2. A method, comprising:
   receiving a first network configuration baseline of a cellular network system, the first network configuration baseline identifying a plurality of configurations of a plurality of components of the cellular network system, the plurality of components comprising plurality of hardware components and a plurality of software components and the plurality of configurations comprising a plurality of hardware configurations of the plurality of hardware components and a plurality of software configurations of the plurality of software components of the cellular network system;
   monitoring the plurality of components using the first network configuration baseline;
   determining at least one network error based at least in part on the monitoring;
   identifying at least one component of the plurality of components corresponding to the at least one network error; and
   generating an alert based at least in part on the at least one network error.
Clause 3. The method of clause 2, wherein the at least one network error comprises at least one of:
   a hardware port assignment that deviates from a hardware port assignment in the first network configuration baseline,
   a software port assignment that deviates from a software port assignment in the first network configuration baseline,
   a hardware configuration of a particular hardware component that is different from a hardware configuration of the particular hardware component in the first network configuration baseline,
   a software version of a particular software component that is different from a software version of the particular software component in the first network configuration baseline,
   a software configuration of the particular software component that is different from a software configuration of the particular software component in the first network configuration baseline,
   network latency that satisfies a network latency threshold,
   packet loss that satisfies a packet loss threshold,
   unauthorized access to at least one hardware component or at least one software component,
   an amount of network traffic that satisfies a network traffic threshold,
   network traffic patterns that deviate a threshold amount from a network traffic pattern threshold,
   a threshold number of failed login attempts,
   network connectivity of the particular hardware component satisfying a network connectivity threshold,
   a power failure of the particular hardware component, or
   power usage of the particular hardware component that satisfies a power usage threshold.
Clause 4. The method of clause 2, wherein the at least one component is at least one hardware component of the plurality of hardware components, the method further comprising:
   identifying at least one configuration of the at least one hardware component that is different from a corresponding configuration of the at least one hardware component in the first network configuration baseline;
   generating a second network configuration baseline for the cellular network system based at least in part on the identified at least one configuration of the at least one hardware component; and
   monitoring the plurality of components using the second network configuration baseline.
Clause 5. The method of clause 4, wherein the at least one network error is a first at least one network error, the method further comprising:
   determining a second at least one network error based at least in part on the monitoring the plurality of components using the second network configuration baseline;
   modifying the identified at least one configuration of the at least one hardware component to the corresponding configuration of the at least one hardware component in the first network configuration baseline; and
   monitoring the plurality of components using the first network configuration baseline.
Clause 6. The method of clause 2, wherein the at least one component is at least one hardware component of the plurality of hardware components, the method further comprising:
   identifying at least one configuration of the at least one hardware component that is different from a corresponding configuration of the at least one hardware component in the first network configuration baseline;
   identifying a plurality of possible configurations for the at least one hardware component to address the at least one network error;
   selecting at least one configuration from the plurality of possible configurations for the at least one hardware component;
   modifying the at least one hardware component in accordance with the selected at least one configuration;
   generating a second network configuration baseline for the cellular network system based at least in part on the modifying the at least one hardware component in accordance with the at least one configuration; and
   monitoring the plurality of components using the second network configuration baseline.
Clause 7. The method of clause 2, wherein the at least one component is at least one hardware component of the plurality of hardware components, the method further comprising:
   determining a power usage of the at least one hardware component satisfies a power usage threshold for the at least one hardware component in the first network configuration baseline;
   identifying, at least one other hardware component of the plurality of hardware components that is available;
   modifying a power usage threshold for the at least one other hardware component based at least in part on the determining the power usage of the at least one hardware component satisfies the power usage threshold for the at least one hardware component;
   adjusting a power distribution associated with the at least one hardware component and the at least one other hardware component; and
   generating an alert based at least in part on the determining the power usage of the at least one hardware component satisfies the power usage threshold for the at least one hardware component.
Clause 8. The method of clause 2, wherein the at least one component is at least one hardware component of the plurality of hardware components, the method further comprising:
   identifying at least one configuration of the at least one hardware component that is different from a corresponding configuration of the at least one hardware component in the first network configuration baseline;
   modifying the identified at least one configuration of the at least one hardware component to the corresponding configuration of the at least one hardware component in the first network configuration baseline;
   updating firmware of the at least one hardware component;
   generating a second network configuration baseline for the cellular network system based at least in part on the updated firmware; and
   monitoring the plurality of components using the second network configuration baseline.
Clause 9. The method of clause 2, wherein the at least one component is at least one software component of the plurality of software components, the method further comprising:
   identifying at least one of a configuration of the at least one software component or a software version of the at least one software component that is different from a corresponding configuration or version, respectively, of the at least one software component in the first network configuration baseline;
   modifying the at least one of the identified configuration or the identified software version of the at least one software component to the corresponding configuration or version, respectively, of the at least one software component in the first network configuration baseline; and
   continue monitoring the plurality of components using the first network configuration baseline.
Clause 10. The method of clause 2, wherein the at least one component is at least one software component of the plurality of software components, the method further comprising:
   identifying at least one of a configuration of the at least one software component or a software version of the at least one software component that is different from a corresponding configuration or version, respectively, of the at least one software component in the first network configuration baseline;
   generating a second network configuration baseline for the cellular network system based at least in part on the at least one of the identified configuration or the identified software version; and
   monitoring the plurality of components using the second network configuration baseline.
Clause 11. The method of clause 10, wherein the at least one network error is a first at least one network error, the method further comprising:
   determining a second at least one network error based at least in part on the monitoring the plurality of components using the second network configuration baseline;
   modifying the at least one of the identified configuration or the identified software version of the at least one software component to the corresponding configuration or version, respectively, of the at least one software component in the first network configuration baseline; and
   monitoring the plurality of components using the first network configuration baseline.
Clause 12. The method of clause 2, wherein the at least one component is at least one software component of the plurality of software components, the method further comprising:
   identifying at least one configuration of the at least one software component that is different from a corresponding configuration of the at least one software component in the first network configuration baseline;
   identifying, using a trained machine learning model, a plurality of possible configurations for the at least one software component to address the at least one network error;
   selecting, using a trained machine learning model, at least one configuration from the plurality of possible configurations for the at least one software component;
   modifying the at least one software component in accordance with the selected at least one configuration;
   generating a second network configuration baseline for the cellular network system based at least in part on the modifying the at least one software component in accordance with the at least one configuration; and
   monitoring the plurality of components using the second network configuration baseline.
Clause 13. A first network control system for network monitoring and controlling, the system comprising:
   a first network configuration baseline stored in a memory;
   a plurality of hardware components of a cellular network system configured according to the first network configuration baseline comprising a plurality of hardware configurations for the plurality of hardware components;
   a plurality of software components of the cellular network system configured according to the first network configuration baseline comprising a plurality of software configurations for the plurality of software components; and
   a processing unit configured to:
      monitor the plurality of hardware components and software components based on the first network configuration baseline,
      wherein the processing unit determines a first network error of at least a first hardware component or at least a first software component does not match the first network configuration baseline;
      generate a second network configuration baseline, wherein the plurality of hardware components and the plurality of software components are monitored based on the second network configuration baseline.
Clause 14. The system of clause 13, wherein the processor is further configured to:
   generate an alert identifying at least the first network error based on determining the at least first hardware component or at least the first software components do not match the first network configuration baseline;
   generate a second network configuration baseline based on identifying the first network error.
Clause 15. The system of clause 13, wherein the system further comprises:
   a machine learning model, trained on a plurality of hardware component configuration and a plurality of software components configuration, wherein the machine learning model identifies at least the first network error based on configuration information of at least a first hardware component or at least a first software component.
Clause 16. The system of clause 13, wherein the system further comprises:
   a second network control system for network monitoring and controlling;
   the second network control system comprising:
      a first network configuration baseline retrieved from the first network control system;
      a plurality of hardware components of the cellular network system configured according to the first network configuration baseline comprising a plurality of hardware configurations for the plurality of hardware components;
      a plurality of software components of the cellular network system configured according to the first network configuration baseline comprising a plurality of software configurations for the plurality of software components; and
      a processing unit configured to:
   monitor the plurality of hardware components and software components based on the first network configuration baseline;
   identify at least the first network error of the at least first hardware component or at least the first network error of the at least first software component based on configuration information not matching the first network configuration baseline;
   modifying the at least first hardware component or at least the first software component in accordance with the first network configuration baseline.
Clause 17. The system of clause 13, wherein the processor is further configured to:
   identify at least the first network error of the at least the first hardware component based on a second version of an operating system of the first hardware component,
   wherein the first network configuration baseline identifies the first hardware component operating system being a first version of the operating system;
   generate a second network configuration baseline based on identifying the first network error.
Clause 18. A non-transitory computer-readable media comprising computer-executable instructions that, when executed by a computing system, cause the computing system to:
   generate a first network configuration baseline based on a plurality of configurations for a plurality of hardware components and a plurality of software components of a cellular network system;
   monitor the plurality of hardware components and the plurality of software components based on the first network configuration baseline;
   determine at least a first hardware component from the plurality of hardware components or a first software component of the plurality of software components does not match at least a first configuration of the plurality of configurations of the first network configuration baseline;
   generate an alert identifying the at least first hardware component or the at least first software component that does not match the first network configuration baseline configuration;
   generate a second network configuration baseline based on the current configurations of the plurality of hardware components and the plurality of software components; and
   monitor the plurality of hardware components and the plurality of software components based on the second network configuration baseline.
Clause 19. The non-transitory computer-readable media of clause 18, wherein the computing system may further modify the plurality of hardware components and the plurality of software components based on the first network configuration baseline based on generating the alert.
Clause 20. The non-transitory computer-readable media of clause 18, wherein the processor is further configured to:
   determine, using a machine learning model trained using a plurality of hardware component configuration and a plurality of software components configuration, at least a first hardware component from the plurality of hardware components or a first software component of the plurality of software components does not match at least a first configuration of the plurality of configurations of the first network configuration baseline;
   generate an alert identifying the at least first hardware component or the at least first software component that does not match the first network configuration baseline configuration
Clause 21: A system, comprising:
   at least one processor configured to:
      receive a first network configuration baseline of a cellular network system, the first network configuration baseline identifying a plurality of configurations of a plurality of components of the cellular network system, the plurality of components comprising plurality of hardware components and a plurality of software components and the plurality of configurations comprising a plurality of hardware configurations of the plurality of hardware components and a plurality of software configurations of the plurality of software components of the cellular network system;
      monitor the plurality of components using the first network configuration baseline;
      determine at least one network error based at least in part on the monitoring;
      identify at least one component of the plurality of components corresponding to the at least one network error; and
      generate an alert based at least in part on the at least one network error.
Clause 22: The system of clause 21, wherein the at least one network error comprises at least one of:
   a hardware port assignment that deviates from a hardware port assignment in the first network configuration baseline,
   a software port assignment that deviates from a software port assignment in the first network configuration baseline,
   a hardware configuration of a particular hardware component that is different from a hardware configuration of the particular hardware component in the first network configuration baseline,
   a software version of a particular software component that is different from a software version of the particular software component in the first network configuration baseline,
   a software configuration of the particular software component that is different from a software configuration of the particular software component in the first network configuration baseline,
   network latency that satisfies a network latency threshold,
   packet loss that satisfies a packet loss threshold,
   unauthorized access to at least one hardware component or at least one software component,
   an amount of network traffic that satisfies a network traffic threshold,
   network traffic patterns that deviate a threshold amount from a network traffic pattern threshold,
   a threshold number of failed login attempts,
   network connectivity of the particular hardware component satisfying a network connectivity threshold,
   a power failure of the particular hardware component, or
   power usage of the particular hardware component that satisfies a power usage threshold.
Clause 23: The system of clause 21, wherein the at least one component is at least one hardware component of the plurality of hardware components, wherein the at least one processor is further configured to:
   identify at least one configuration of the at least one hardware component that is different from a corresponding configuration of the at least one hardware component in the first network configuration baseline;
   generate a second network configuration baseline for the cellular network system based at least in part on the identified at least one configuration of the at least one hardware component; and
   monitor the plurality of components using the second network configuration baseline.
Clause 24: The system of clause 23, wherein the at least one network error is a first at least one network error, wherein the at least one processor is further configured to:
   determine a second at least one network error based at least in part on the monitoring the plurality of components using the second network configuration baseline;
   modify the identified at least one configuration of the at least one hardware component to the corresponding configuration of the at least one hardware component in the first network configuration baseline; and
   monitor the plurality of components using the first network configuration baseline.
Clause 25: The system of clause 21, wherein the at least one component is at least one hardware component of the plurality of hardware components, wherein the at least one processor is further configured to:
   identify at least one configuration of the at least one hardware component that is different from a corresponding configuration of the at least one hardware component in the first network configuration baseline;
   identify a plurality of possible configurations for the at least one hardware component to address the at least one network error;
   select at least one configuration from the plurality of possible configurations for the at least one hardware component;
   modify the at least one hardware component in accordance with the selected at least one configuration;
   generate a second network configuration baseline for the cellular network system based at least in part on the modifying the at least one hardware component in accordance with the at least one configuration; and
   monitor the plurality of components using the second network configuration baseline.
Clause 26: The system of clause 21, wherein the at least one component is at least one hardware component of the plurality of hardware components, wherein the at least one processor is further configured to:
   determine a power usage of the at least one hardware component satisfies a power usage threshold for the at least one hardware component in the first network configuration baseline;
   identify, at least one other hardware component of the plurality of hardware components that is available;
   modify a power usage threshold for the at least one other hardware component based at least in part on the determining the power usage of the at least one hardware component satisfies the power usage threshold for the at least one hardware component;
   adjust a power distribution associated with the at least one hardware component and the at least one other hardware component; and
   generate an alert based at least in part on the determining the power usage of the at least one hardware component satisfies the power usage threshold for the at least one hardware component.
Clause 26: The system of clause 21, wherein the at least one component is at least one hardware component of the plurality of hardware components, wherein the at least one processor is further configured to:
   identify at least one configuration of the at least one hardware component that is different from a corresponding configuration of the at least one hardware component in the first network configuration baseline;
   modify the identified at least one configuration of the at least one hardware component to the corresponding configuration of the at least one hardware component in the first network configuration baseline;
   update firmware of the at least one hardware component;
   generate a second network configuration baseline for the cellular network system based at least in part on the updated firmware; and
   monitor the plurality of components using the second network configuration baseline.
Clause 27: The system of clause 21, wherein the at least one component is at least one software component of the plurality of software components, wherein the at least one processor is further configured to:
   identify at least one of a configuration of the at least one software component or a software version of the at least one software component that is different from a corresponding configuration or version, respectively, of the at least one software component in the first network configuration baseline;
   modify the at least one of the identified configuration or the identified software version of the at least one software component to the corresponding configuration or version, respectively, of the at least one software component in the first network configuration baseline; and
   continue to monitor the plurality of components using the first network configuration baseline.
Clause 28: The system of clause 21, wherein the at least one component is at least one software component of the plurality of software components, wherein the at least one processor is further configured to:
   identify at least one of a configuration of the at least one software component or a software version of the at least one software component that is different from a corresponding configuration or version, respectively, of the at least one software component in the first network configuration baseline;
   generate a second network configuration baseline for the cellular network system based at least in part on the at least one of the identified configuration or the identified software version; and
   monitor the plurality of components using the second network configuration baseline.
Clause 29: The system of clause 28, wherein the at least one network error is a first at least one network error, wherein the at least one processor is further configured to:
   determine a second at least one network error based at least in part on the monitoring the plurality of components using the second network configuration baseline;
   modify the at least one of the identified configuration or the identified software version of the at least one software component to the corresponding configuration or version, respectively, of the at least one software component in the first network configuration baseline; and
   monitor the plurality of components using the first network configuration baseline.
Clause 30: The system of clause 21, wherein the at least one component is at least one software component of the plurality of software components, wherein the at least one processor is further configured to:
   identify at least one configuration of the at least one software component that is different from a corresponding configuration of the at least one software component in the first network configuration baseline;
   identify, using a trained machine learning model, a plurality of possible configurations for the at least one software component to address the at least one network error;
   select, using a trained machine learning model, at least one configuration from the plurality of possible configurations for the at least one software component;
   modify the at least one software component in accordance with the selected at least one configuration;
   generate a second network configuration baseline for the cellular network system based at least in part on the modifying the at least one software component in accordance with the at least one configuration; and
   monitor the plurality of components using the second network configuration baseline.
Clause 31: A non-transitory computer-readable medium comprising computer executable instructions that, when executed by at least one processor, cause the at least one processor to:
   receive a first network configuration baseline of a cellular network system, the first network configuration baseline identifying a plurality of configurations of a plurality of components of the cellular network system, the plurality of components comprising plurality of hardware components and a plurality of software components and the plurality of configurations comprising a plurality of hardware configurations of the plurality of hardware components and a plurality of software configurations of the plurality of software components of the cellular network system;
   monitor the plurality of components using the first network configuration baseline;
   determine at least one network error based at least in part on the monitoring;
   identify at least one component of the plurality of components corresponding to the at least one network error; and
   generate an alert based at least in part on the at least one network error.
Clause 32: The non-transitory computer-readable medium of clause 31, wherein the at least one network error comprises at least one of:
   a hardware port assignment that deviates from a hardware port assignment in the first network configuration baseline,
   a software port assignment that deviates from a software port assignment in the first network configuration baseline,
   a hardware configuration of a particular hardware component that is different from a hardware configuration of the particular hardware component in the first network configuration baseline,
   a software version of a particular software component that is different from a software version of the particular software component in the first network configuration baseline,
   a software configuration of the particular software component that is different from a software configuration of the particular software component in the first network configuration baseline,
   network latency that satisfies a network latency threshold,
   packet loss that satisfies a packet loss threshold,
   unauthorized access to at least one hardware component or at least one software component,
   an amount of network traffic that satisfies a network traffic threshold,
   network traffic patterns that deviate a threshold amount from a network traffic pattern threshold,
   a threshold number of failed login attempts,
   network connectivity of the particular hardware component satisfying a network connectivity threshold,
   a power failure of the particular hardware component, or
   power usage of the particular hardware component that satisfies a power usage threshold.
Clause 33: The non-transitory computer-readable medium of clause 31, wherein the at least one component is at least one hardware component of the plurality of hardware components, wherein the computer-executable instructions further cause the at least one processor to:
   identify at least one configuration of the at least one hardware component that is different from a corresponding configuration of the at least one hardware component in the first network configuration baseline;
   generate a second network configuration baseline for the cellular network system based at least in part on the identified at least one configuration of the at least one hardware component; and
   monitor the plurality of components using the second network configuration baseline.
Clause 34: The non-transitory computer-readable medium of clause 33, wherein the at least one network error is a first at least one network error, wherein the computer-executable instructions further cause the at least one processor to:
   determine a second at least one network error based at least in part on the monitoring the plurality of components using the second network configuration baseline;
   modify the identified at least one configuration of the at least one hardware component to the corresponding configuration of the at least one hardware component in the first network configuration baseline; and
   monitor the plurality of components using the first network configuration baseline.
Clause 35: The non-transitory computer-readable medium of clause 31, wherein the at least one component is at least one hardware component of the plurality of hardware components, wherein the computer-executable instructions further cause the at least one processor to:
   identify at least one configuration of the at least one hardware component that is different from a corresponding configuration of the at least one hardware component in the first network configuration baseline;
   identify a plurality of possible configurations for the at least one hardware component to address the at least one network error;
   select at least one configuration from the plurality of possible configurations for the at least one hardware component;
   modify the at least one hardware component in accordance with the selected at least one configuration;
   generate a second network configuration baseline for the cellular network system based at least in part on the modifying the at least one hardware component in accordance with the at least one configuration; and
   monitor the plurality of components using the second network configuration baseline.
Clause 36: The non-transitory computer-readable medium of clause 31, wherein the at least one component is at least one hardware component of the plurality of hardware components, wherein the computer-executable instructions further cause the at least one processor to:
   determine a power usage of the at least one hardware component satisfies a power usage threshold for the at least one hardware component in the first network configuration baseline;
   identify, at least one other hardware component of the plurality of hardware components that is available;
   modify a power usage threshold for the at least one other hardware component based at least in part on the determining the power usage of the at least one hardware component satisfies the power usage threshold for the at least one hardware component;
   adjust a power distribution associated with the at least one hardware component and the at least one other hardware component; and
   generate an alert based at least in part on the determining the power usage of the at least one hardware component satisfies the power usage threshold for the at least one hardware component.
Clause 37: The non-transitory computer-readable medium of clause 31, wherein the at least one component is at least one hardware component of the plurality of hardware components, wherein the computer-executable instructions further cause the at least one processor to:
   identify at least one configuration of the at least one hardware component that is different from a corresponding configuration of the at least one hardware component in the first network configuration baseline;
   modify the identified at least one configuration of the at least one hardware component to the corresponding configuration of the at least one hardware component in the first network configuration baseline;
   update firmware of the at least one hardware component;
   generate a second network configuration baseline for the cellular network system based at least in part on the updated firmware; and
   monitor the plurality of components using the second network configuration baseline.
Clause 38: The non-transitory computer-readable medium of clause 31, wherein the at least one component is at least one software component of the plurality of software components, wherein the computer-executable instructions further cause the at least one processor to:
   identify at least one of a configuration of the at least one software component or a software version of the at least one software component that is different from a corresponding configuration or version, respectively, of the at least one software component in the first network configuration baseline;
   modify the at least one of the identified configuration or the identified software version of the at least one software component to the corresponding configuration or version, respectively, of the at least one software component in the first network configuration baseline; and
   continue to monitor the plurality of components using the first network configuration baseline.
Clause 39: The non-transitory computer-readable medium of clause 31, wherein the at least one component is at least one software component of the plurality of software components, wherein the computer-executable instructions further cause the at least one processor to:
   identify at least one of a configuration of the at least one software component or a software version of the at least one software component that is different from a corresponding configuration or version, respectively, of the at least one software component in the first network configuration baseline;
   generate a second network configuration baseline for the cellular network system based at least in part on the at least one of the identified configuration or the identified software version; and
   monitor the plurality of components using the second network configuration baseline.
Clause 40: The non-transitory computer-readable medium of clause 39, wherein the at least one network error is a first at least one network error, wherein the computer-executable instructions further cause the at least one processor to:
   determine a second at least one network error based at least in part on the monitoring the plurality of components using the second network configuration baseline;
   modify the at least one of the identified configuration or the identified software version of the at least one software component to the corresponding configuration or version, respectively, of the at least one software component in the first network configuration baseline; and
   monitor the plurality of components using the first network configuration baseline.
Clause 41: The non-transitory computer-readable medium of clause 31, wherein the at least one component is at least one software component of the plurality of software components, wherein the computer-executable instructions further cause the at least one processor to:
   identify at least one configuration of the at least one software component that is different from a corresponding configuration of the at least one software component in the first network configuration baseline;
   identify, using a trained machine learning model, a plurality of possible configurations for the at least one software component to address the at least one network error;
   select, using a trained machine learning model, at least one configuration from the plurality of possible configurations for the at least one software component;
   modify the at least one software component in accordance with the selected at least one configuration;
   generate a second network configuration baseline for the cellular network system based at least in part on the modifying the at least one software component in accordance with the at least one configuration; and
   monitor the plurality of components using the second network configuration baseline.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Depending on the embodiment, certain operations, acts, events, or functions of any of the algorithms described herein can be performed in a different sequence, can be added, merged, or left out altogether (e.g., not all are necessary for the practice of the algorithms). Moreover, in certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described herein. Software and other modules may reside and execute on servers, workstations, personal computers, computerized tablets, PDAs, and other computing devices suitable for the purposes described herein. Software and other modules may be accessible via local memory, via a network, via a browser, or via other means suitable for the purposes described herein. Data structures described herein may comprise computer files, variables, programming arrays, programming structures, or any electronic information storage schemes or methods, or any combinations thereof suitable for the purposes described herein. User interface elements described herein may comprise elements from graphical user interfaces, interactive voice response, command line interfaces, and other suitable interfaces.

Further, the processing of the various components of the illustrated systems can be distributed across multiple machines, networks, and other computing resources. In addition, two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks.

These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded onto a computing device or other programmable data processing apparatus to cause a series of operations to be performed on the computing device or other programmable apparatus to produce a computer implemented process such that the instructions which execute on the computer or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention may be recited as a means-plus-function claim under 35 U.S.C sec. 112(f) (AIA), other aspects may likewise be embodied as a means-plus-function claim, or in other forms, such as being embodied in a computer-readable medium. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application, in either this application or in a continuing application.

What is claimed:

1. A method, comprising:
receiving a first network configuration baseline of a cellular network system, the first network configuration baseline identifying a plurality of configurations of a plurality of components of the cellular network system,
wherein the plurality of components comprises a plurality of hardware components and a plurality of software components,
wherein the plurality of configurations comprise a plurality of hardware configurations for the plurality of hardware components and a plurality of software configurations for the plurality of software components of the cellular network system;
monitoring the plurality of hardware components and the plurality of software components using the first network configuration baseline;
determining at least one network error based at least in part on the monitoring;
identifying at least one hardware component of the plurality of hardware components corresponding to the at least one network error;
identifying at least one configuration of the at least one hardware component that is different from a corresponding configuration of the at least one hardware component in the first network configuration baseline;
identifying, using a trained machine learning model, a plurality of possible configurations for the at least one hardware component to address the at least one network error;
selecting, using a trained machine learning model, at least one configuration from the plurality of possible configurations for the at least one hardware component;
modifying the at least one hardware component in accordance with the selected at least one configuration;
generating a second network configuration baseline for the cellular network system based at least in part on the modifying the at least one hardware component in accordance with the at least one configuration; and
monitoring the plurality of hardware components and the plurality of software components using the second network configuration baseline.

2. A method, comprising:
receiving a first network configuration baseline of a cellular network system, the first network configuration baseline identifying a plurality of configurations of a plurality of components of the cellular network system, the plurality of components comprising plurality of hardware components and a plurality of software components and the plurality of configurations comprising a plurality of hardware configurations of the plurality of hardware components and a plurality of software configurations of the plurality of software components of the cellular network system;
monitoring the plurality of components using the first network configuration baseline;
determining at least one network error based at least in part on the monitoring;
identifying at least one component of the plurality of components corresponding to the at least one network error; and
generating an alert based at least in part on the at least one network error.

3. The method of claim 2, wherein the at least one network error comprises at least one of:
a hardware port assignment that deviates from a hardware port assignment in the first network configuration baseline,
a software port assignment that deviates from a software port assignment in the first network configuration baseline,
a hardware configuration of a particular hardware component that is different from a hardware configuration of the particular hardware component in the first network configuration baseline,
a software version of a particular software component that is different from a software version of the particular software component in the first network configuration baseline,
a software configuration of the particular software component that is different from a software configuration of the particular software component in the first network configuration baseline,
network latency that satisfies a network latency threshold,
packet loss that satisfies a packet loss threshold,
unauthorized access to at least one hardware component or at least one software component,
an amount of network traffic that satisfies a network traffic threshold,
network traffic patterns that deviate a threshold amount from a network traffic pattern threshold,
a threshold number of failed login attempts,
network connectivity of the particular hardware component satisfying a network connectivity threshold,
a power failure of the particular hardware component, or
power usage of the particular hardware component that satisfies a power usage threshold.

4. The method of claim 2, wherein the at least one component is at least one hardware component of the plurality of hardware components, the method further comprising:
identifying at least one configuration of the at least one hardware component that is different from a corresponding configuration of the at least one hardware component in the first network configuration baseline;
generating a second network configuration baseline for the cellular network system based at least in part on the identified at least one configuration of the at least one hardware component; and
monitoring the plurality of components using the second network configuration baseline.

5. The method of claim 4, wherein the at least one network error is a first at least one network error, the method further comprising:
determining a second at least one network error based at least in part on the monitoring the plurality of components using the second network configuration baseline;
modifying the identified at least one configuration of the at least one hardware component to the corresponding configuration of the at least one hardware component in the first network configuration baseline; and
monitoring the plurality of components using the first network configuration baseline.

6. The method of claim 2, wherein the at least one component is at least one hardware component of the plurality of hardware components, the method further comprising:
identifying at least one configuration of the at least one hardware component that is different from a corresponding configuration of the at least one hardware component in the first network configuration baseline;
identifying a plurality of possible configurations for the at least one hardware component to address the at least one network error;
selecting at least one configuration from the plurality of possible configurations for the at least one hardware component;
modifying the at least one hardware component in accordance with the selected at least one configuration;
generating a second network configuration baseline for the cellular network system based at least in part on the modifying the at least one hardware component in accordance with the at least one configuration; and
monitoring the plurality of components using the second network configuration baseline.

7. The method of claim 2, wherein the at least one component is at least one hardware component of the plurality of hardware components, the method further comprising:
determining a power usage of the at least one hardware component satisfies a power usage threshold for the at least one hardware component in the first network configuration baseline;
identifying, at least one other hardware component of the plurality of hardware components that is available;
modifying a power usage threshold for the at least one other hardware component based at least in part on the determining the power usage of the at least one hardware component satisfies the power usage threshold for the at least one hardware component;
adjusting a power distribution associated with the at least one hardware component and the at least one other hardware component; and
generating an alert based at least in part on the determining the power usage of the at least one hardware component satisfies the power usage threshold for the at least one hardware component.

8. The method of claim 2, wherein the at least one component is at least one hardware component of the plurality of hardware components, the method further comprising:
identifying at least one configuration of the at least one hardware component that is different from a corresponding configuration of the at least one hardware component in the first network configuration baseline;
modifying the identified at least one configuration of the at least one hardware component to the corresponding configuration of the at least one hardware component in the first network configuration baseline;
updating firmware of the at least one hardware component;
generating a second network configuration baseline for the cellular network system based at least in part on the updated firmware; and
monitoring the plurality of components using the second network configuration baseline.

9. The method of claim 2, wherein the at least one component is at least one software component of the plurality of software components, the method further comprising:
identifying at least one of a configuration of the at least one software component or a software version of the at least one software component that is different from a corresponding configuration or version, respectively, of the at least one software component in the first network configuration baseline;
modifying the at least one of the identified configuration or the identified software version of the at least one software component to the corresponding configuration or version, respectively, of the at least one software component in the first network configuration baseline; and
continue monitoring the plurality of components using the first network configuration baseline.

10. The method of claim 2, wherein the at least one component is at least one software component of the plurality of software components, the method further comprising:
identifying at least one of a configuration of the at least one software component or a software version of the at least one software component that is different from a corresponding configuration or version, respectively, of the at least one software component in the first network configuration baseline;
generating a second network configuration baseline for the cellular network system based at least in part on the at least one of the identified configuration or the identified software version; and
monitoring the plurality of components using the second network configuration baseline.

11. The method of claim 10, wherein the at least one network error is a first at least one network error, the method further comprising:
determining a second at least one network error based at least in part on the monitoring the plurality of components using the second network configuration baseline;
modifying the at least one of the identified configuration or the identified software version of the at least one software component to the corresponding configuration or version, respectively, of the at least one software component in the first network configuration baseline; and
monitoring the plurality of components using the first network configuration baseline.

12. The method of claim 2, wherein the at least one component is at least one software component of the plurality of software components, the method further comprising:
identifying at least one configuration of the at least one software component that is different from a corresponding configuration of the at least one software component in the first network configuration baseline;
identifying, using a trained machine learning model, a plurality of possible configurations for the at least one software component to address the at least one network error;
selecting, using a trained machine learning model, at least one configuration from the plurality of possible configurations for the at least one software component;
modifying the at least one software component in accordance with the selected at least one configuration;
generating a second network configuration baseline for the cellular network system based at least in part on the modifying the at least one software component in accordance with the at least one configuration; and
monitoring the plurality of components using the second network configuration baseline.

13. A system, comprising:
at least one processor configured to:
receive a first network configuration baseline of a cellular network system, the first network configuration baseline identifying a plurality of configurations of a plurality of components of the cellular network system, the plurality of components comprising plurality of hardware components and a plurality of software components and the plurality of configurations comprising a plurality of hardware configurations of the plurality of hardware components and a plurality of software configurations of the plurality of software components of the cellular network system;
monitor the plurality of components using the first network configuration baseline;
determine at least one network error based at least in part on the monitoring;
identify at least one component of the plurality of components corresponding to the at least one network error; and
generate an alert based at least in part on the at least one network error.

14. The system of claim 13, wherein the at least one component is at least one hardware component of the plurality of hardware components, wherein the at least one processor is further configured to:
identify at least one configuration of the at least one hardware component that is different from a corresponding configuration of the at least one hardware component in the first network configuration baseline;
generate a second network configuration baseline for the cellular network system based at least in part on the identified at least one configuration of the at least one hardware component; and
monitor the plurality of components using the second network configuration baseline.

15. The system of claim 14, wherein the at least one network error is a first at least one network error, wherein the at least one processor is further configured to:
determine a second at least one network error based at least in part on the monitoring the plurality of components using the second network configuration baseline;
modify the identified at least one configuration of the at least one hardware component to the corresponding configuration of the at least one hardware component in the first network configuration baseline; and
monitor the plurality of components using the first network configuration baseline.

16. The system of claim 13, wherein the at least one component is at least one hardware component of the plurality of hardware components, wherein the at least one processor is further configured to:
identify at least one configuration of the at least one hardware component that is different from a corresponding configuration of the at least one hardware component in the first network configuration baseline;
identify a plurality of possible configurations for the at least one hardware component to address the at least one network error;
select at least one configuration from the plurality of possible configurations for the at least one hardware component;
modify the at least one hardware component in accordance with the selected at least one configuration;
generate a second network configuration baseline for the cellular network system based at least in part on the modifying the at least one hardware component in accordance with the at least one configuration; and
monitor the plurality of components using the second network configuration baseline.

17. The system of claim 13, wherein the at least one component is at least one hardware component of the plurality of hardware components, wherein the at least one processor is further configured to:
determine a power usage of the at least one hardware component satisfies a power usage threshold for the at least one hardware component in the first network configuration baseline;
identify, at least one other hardware component of the plurality of hardware components that is available;
modify a power usage threshold for the at least one other hardware component based at least in part on the determining the power usage of the at least one hardware component satisfies the power usage threshold for the at least one hardware component;
adjust a power distribution associated with the at least one hardware component and the at least one other hardware component; and
generate an alert based at least in part on the determining the power usage of the at least one hardware component satisfies the power usage threshold for the at least one hardware component.

18. The system of claim 13, wherein the at least one component is at least one hardware component of the plurality of hardware components, wherein the at least one processor is further configured to:
identify at least one configuration of the at least one hardware component that is different from a corresponding configuration of the at least one hardware component in the first network configuration baseline;
modify the identified at least one configuration of the at least one hardware component to the corresponding configuration of the at least one hardware component in the first network configuration baseline;
update firmware of the at least one hardware component;
generate a second network configuration baseline for the cellular network system based at least in part on the updated firmware; and
monitor the plurality of components using the second network configuration baseline.

19. A non-transitory computer-readable medium comprising computer executable instructions that, when executed by at least one processor, cause the at least one processor to:
receive a first network configuration baseline of a cellular network system, the first network configuration baseline identifying a plurality of configurations of a plurality of components of the cellular network system, the plurality of components comprising plurality of hardware components and a plurality of software components and the plurality of configurations comprising a plurality of hardware configurations of the plurality of hardware components and a plurality of software configurations of the plurality of software components of the cellular network system;
monitor the plurality of components using the first network configuration baseline;
determine at least one network error based at least in part on the monitoring;
identify at least one component of the plurality of components corresponding to the at least one network error; and
generate an alert based at least in part on the at least one network error.

20. The non-transitory computer-readable medium of claim 19, wherein the at least one component is at least one hardware component of the plurality of hardware components, wherein the computer-executable instructions further cause the at least one processor to:
identify at least one configuration of the at least one hardware component that is different from a corresponding configuration of the at least one hardware component in the first network configuration baseline;
identify a plurality of possible configurations for the at least one hardware component to address the at least one network error;
select at least one configuration from the plurality of possible configurations for the at least one hardware component;
modify the at least one hardware component in accordance with the selected at least one configuration;
generate a second network configuration baseline for the cellular network system based at least in part on the modifying the at least one hardware component in accordance with the at least one configuration; and
monitor the plurality of components using the second network configuration baseline.
